(19) United States
(12) Patent Application Publication
(10) Pub. No.: US 2019/0181983 A1
(43) Pub. Date: Jun. 13, 2019

(54) ADVANCED POLAR CODES FOR NEXT GENERATION WIRELESS COMMUNICATION SYSTEMS

(71) Applicant: IDAC Holdings, Inc., Wilmington, DE (US)

(72) Inventors: Chunxuan Ye, San Diego, CA (US); Fengjun Xi, San Diego, CA (US); Kyle Jung-Lin Pan, Saint James, NY (US); Nirav B Shah, San Diego, CA (US)

(21) Appl. No.: 16/324,276

(22) PCT Filed: Aug. 10, 2017
(86) PCT No.: PCT/US17/46201

§ 371 Date: Feb. 8, 2019

Related U.S. Application Data
(60) Provisional application No. 62/500,660, filed on May 3, 2017.
(60) Provisional application No. 62/474,828, filed on Mar. 22, 2017.
(60) Provisional application No. 62/443,423, filed on Jan. 6, 2017.
(60) Provisional application No. 62/400,946, filed on Sep. 28, 2016.
(60) Provisional application No. 62/373,155, filed on Aug. 10, 2016.

(51) Int. Cl. H04L 1/00

(52) U.S. Cl. CPC H04L 1/0068; H04B 1/38; H04L 1/0013; H04L 1/0058

(57) ABSTRACT

Systems, methods, and instrumentalities may be disclosed for polar coding. For example, a wireless transmit/receive unit (WTRU) may identify a coding rate and/or an information block length. The WTRU may determine a codeword length, for example, based on the coding rate and/or the information block length. The WTRU may identify a channel condition and/or decoding error statistics. The WTRU may determine a polar code construction type, for example, based on the channel condition and/or the decoding error statistics. The WTRU may determine a design signal to noise ratio (SNR) based on the channel condition and/or the decoding error statistics. The WTRU may determine a polar code based on the information block length, the codeword length, the polar code construction type, and/or the design SNR. The WTRU may encode source bits based on the polar code.

### CROSS REFERENCE TO RELATED APPLICATIONS

This application claims the benefit of U.S. Provisional Patent Application No. 62/373,155, filed Aug. 10, 2016, U.S. Provisional Patent Application No. 62/400,946, filed Sep. 28, 2016, U.S. Provisional Patent Application No. 62/443,423, filed Jan. 6, 2017, U.S. Provisional Patent Application No. 62/474,828, filed Mar. 22, 2017, and U.S. Provisional Patent Application No. 62/500,660, filed May 3, 2017, all of which are hereby incorporated by reference herein.

### BACKGROUND

Mobile communications continue to evolve. A fifth generation may be referred to as 5G.

### SUMMARY

Systems, methods, and instrumentalities are disclosed for polar code adaptation. Polar codes may be adapted by adapting, modifying, and/or changing a polar code construction parameter, for example, based on monitored information. Monitored information may include a communication channel condition, a decoding error statistic, and/or a communication device capability. Polar code adaptation may include selecting one or more of a different design (signal to noise ratio) SNR, a different type (e.g., construction type) of polar code, a different puncturing scheme, a different codeword length and a different number of punctured bits. For example, a channel SNR-based adaptive polar coding system may achieve better performance by adapting to different channel conditions. Individual or combined (e.g., hybrid) puncturing schemes (e.g., mixing a quasi-uniform scheme and a weight-1 column reduction scheme) may be adapted, modified, and/or changed. Polar encoding and decoding subsystems may provide adaptations, including, for example, for MIMO systems.

Systems, methods, and instrumentalities may be disclosed for polar coding. For example, a wireless transmit/receive unit (WTRU) may identify a coding rate and/or an information block length. The WTRU may determine a codeword length, for example, based on the coding rate and/or the information block length. The WTRU may identify a channel condition and/or decoding error statistics. The WTRU may determine a polar code type (e.g., construction type), for example, based on the channel condition and/or the decoding error statistics. The WTRU may determine a design signal to noise ratio (SNR) based on the channel condition and/or the decoding error statistics. The WTRU may determine a polar code based on the information block length, the codeword length, the polar code type (e.g., construction type), and/or the design SNR. The WTRU may encode source bits based on the polar code.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is an example of a Polar encoder with N=8.

FIG. 2B is an example of a Parity Check (PC) polar code.

FIG. 3 is an example of block error rate (BLER) with different design signal to noise ratio (SNR) for polar coding.

FIG. 4 is an example of a decision making process that may be implemented at a transmitter (Tx) and a receiver (Rx).

FIG. 5 is an example of a message flow for polar code updates.

FIG. 6 is an example of quasi-uniform puncturing scheme 2.

FIG. 7 is an example of weight-1 column reduction scheme 1.

FIG. 8 is an example of a weight-1 column reduction scheme 2.

FIG. 9 is an example of puncturing scheme performance where 50 bits are punctured.

FIG. 10 is an example of puncturing scheme performance where 100 bits are punctured.

FIG. 11 is an example of puncturing scheme performance where 250 bits are punctured.

FIG. 12 is an example of puncturing scheme performance where 200 bits are punctured at list 4 and list 32.

FIG. 13 is an example of a hybrid puncturing scheme.

FIG. 14 is an example of a message flow for polar code puncturing scheme updates.

FIG. 15 is an example of a quasi-uniform puncturing scheme 2 without encoder BR.

FIG. 16 is an example of a weight-1 column reduction scheme 1 without encoder BR.

FIG. 17 is an example of a weight-1 column reduction scheme 2 without encoder BR.

FIG. 18 is an example of a puncturing scheme without encoder BR.

FIG. 19 is an example of a mixed puncturing scheme.

FIG. 20 is an example of BLER performance comparison between a mixed puncturing scheme, a distribution puncturing scheme, and a weight-1 column reduction scheme.

FIG. 21 is an example of an adaptive polar encoding sub-system.

FIG. 22 is an example of BLER performance comparison with a polar code of Bhattacharyya bounds.

FIG. 23 is an example of BLER performance comparison with a polar code of Gaussian approximation.

FIG. 24 is an example of BLER performance comparison with a polar code of Bhattacharyya bounds for different interleaves for 64QAM modulation.

FIG. 25 is an example of BLER performance comparison with a polar code of Bhattacharyya bounds for different interleaves for QPSK and 16QAM modulations.

FIG. 26 is an example of an adaptive polar decoding sub-system.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

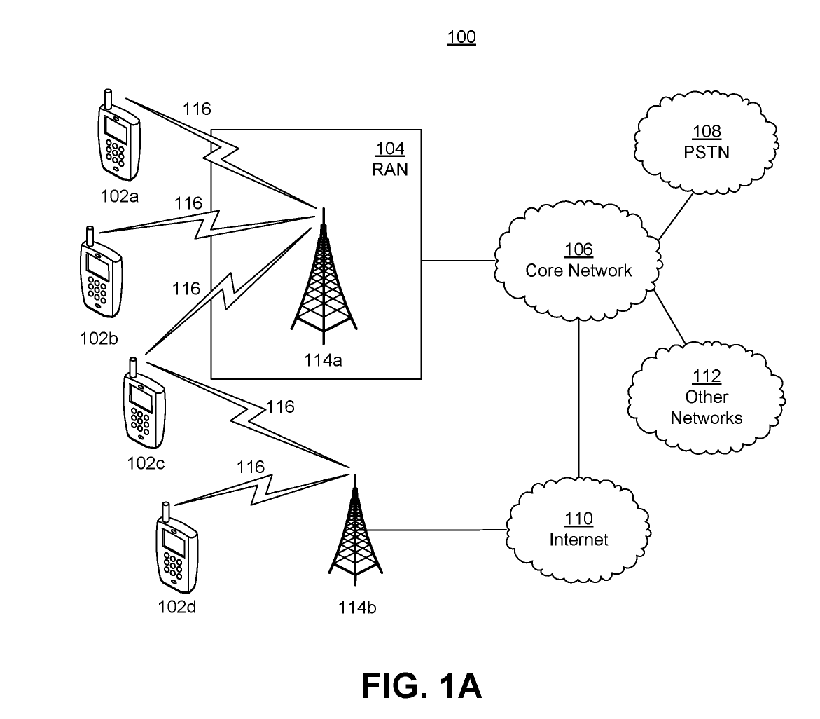

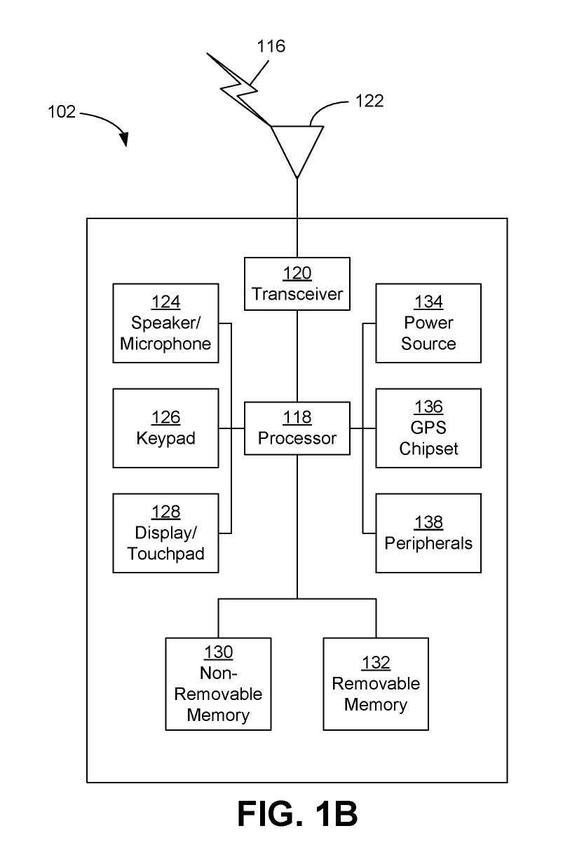

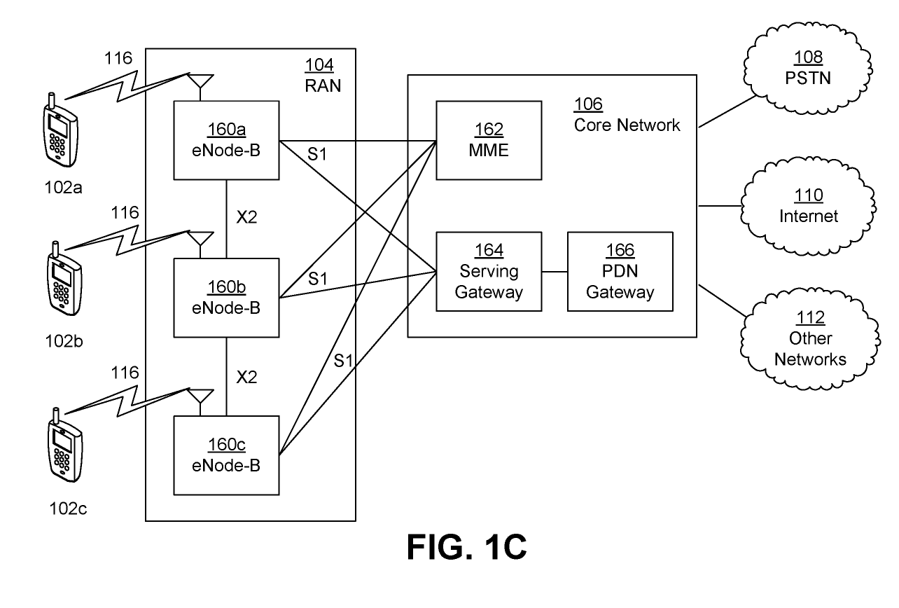

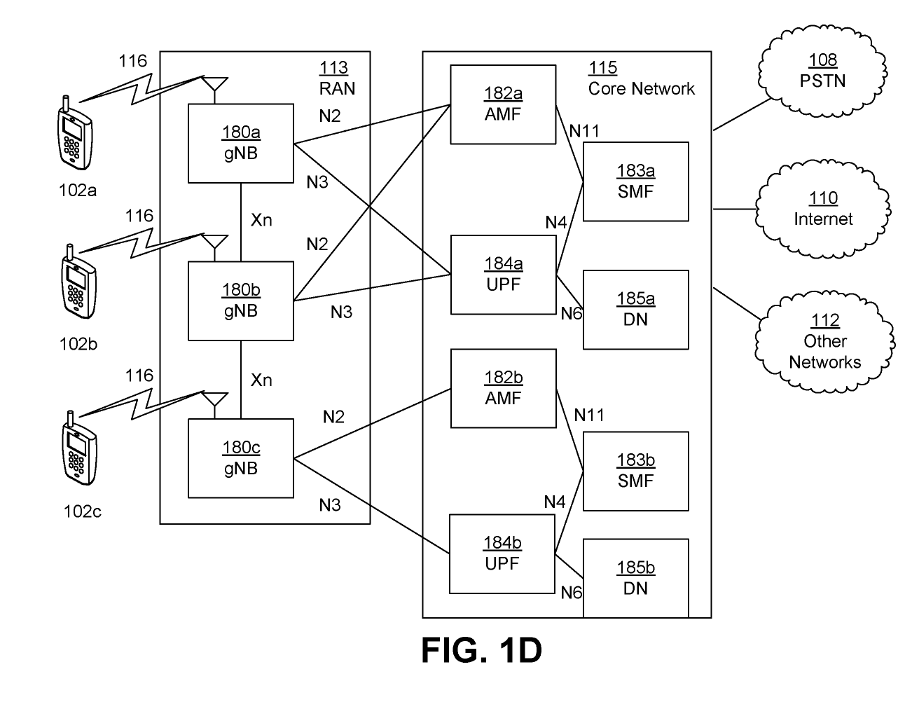

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B. or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Polar codes may be capacity achieving codes. For example, polar codes may be capacity achieving codes like Turbo codes and/or LDPC codes. Polar codes may be linear block codes. Polar codes may have low encoding and/or decoding complexity. Polar codes may have a low error floor and/or explicit construction schemes.

In an example of an (N, K) polar code, the value K may be an information block length and/or the value N may be a coded block length. The value N may be set as a power of 2 for some integer n. For example, the value N may equal to 2ⁿ, for an integer n. Polar codes may be linear block codes. A generator matrix of a polar code may be expressed by G_{N}=B_{N}F^{⊗n}, where B_{N} may be a bit-reversal permutation matrix, where (.)^{⊗n} may denote the n-th Kronecker power, and/or where

$$F = [ \begin{matrix}1 & 0 \\ 1 & 1\end{matrix} ] .$$

In an example, a polar code, B_{N} may be ignored at the encoder side and/or a bit-reversal may be performed on the decoder side.

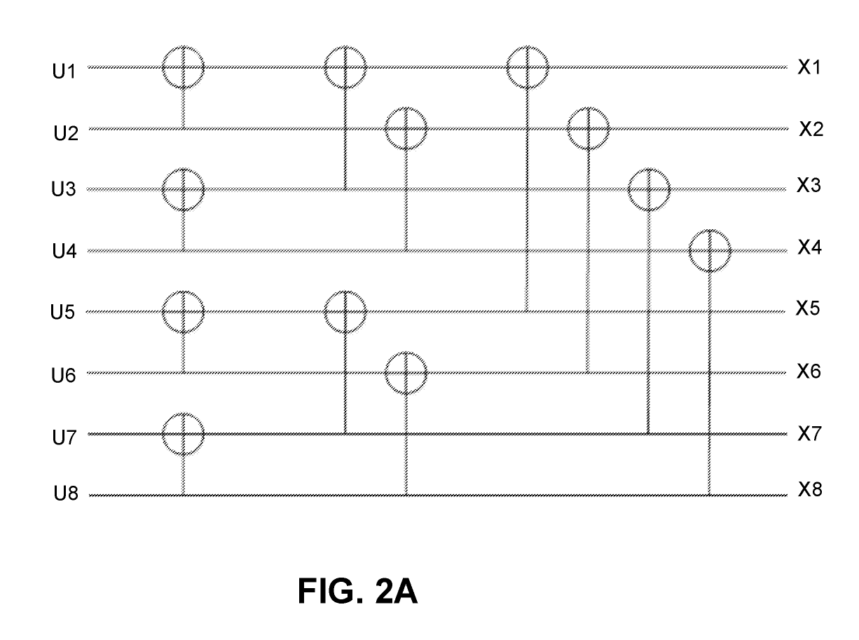

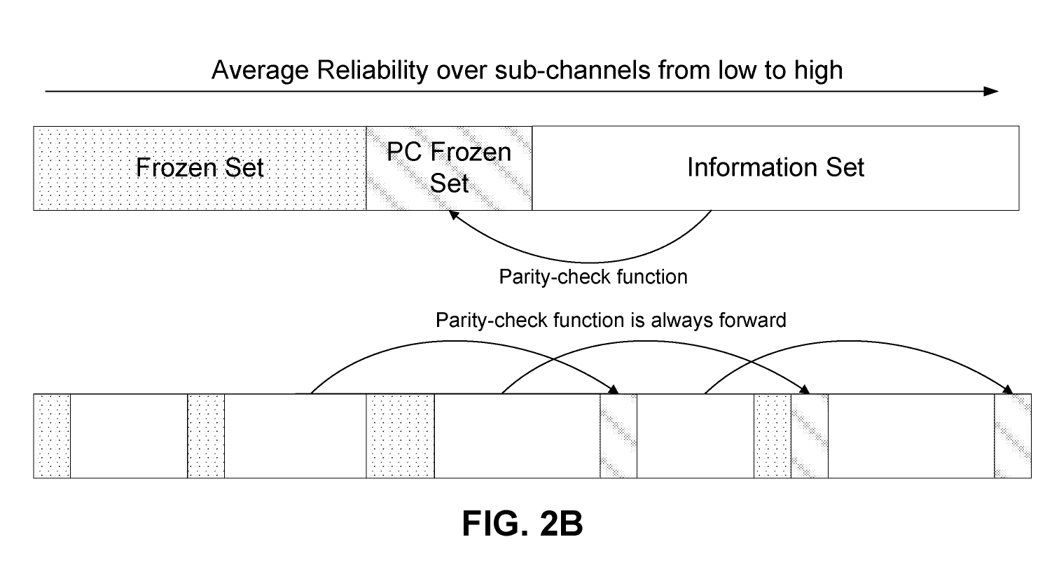

FIG. 2A is an example of a Polar encoder with N=8. FIG. 2A shows an example implementation of F^{⊗3}. The codeword of a polar code may be given by x₁ⁿ=u₁^{N}G_{N}. Decoding schemes may include Successive Cancellation (SC) decoding and/or advanced decoding schemes based on SC decoding. For example, decoding schemes may include Successive Cancellation List (SCL) decoding and/or CRC-Aided SCL decoding.

Polar codes may be structured in terms of encoding and/or decoding. A polar code (e.g., a successful polar code) may depend on the mapping of K information bits to N input bits of a polar encoder u₁^{N}. K information bits may be put on the K best bit channels. The remaining N−K input bits (e.g., the input bits that may not be mapped from the information bits) may be referred to as frozen bits. The frozen bits may be set to 0. A set of positions for frozen bits may be referred to as frozen set [symbol] .

The decision on the best bit channels may vary and/or may depend on channel conditions (e.g., real channel conditions). Bit channels may be ranked (e.g., ranked based on the reliabilities of the bit channels). For example, bit channels may be ranked when determining the set of frozen channels. Reliable bit channels may be good bit channels. Less reliable bit channels may be bad bit channels.

The reliability of a bit channel may be calculated in one or more of the following ways, in any combination. For example, reliabilities of bit channels may be determined using Bhattacharyya bounds, Monte-Carlo estimation, full transition probability matrices estimation, and/or Gaussian approximation. Various schemes may comprise different computation complexities and/or may apply to different channel conditions. A scheme may have a parameter design SNR that may be selected for use in calculating reliabilities.

A Parity Check (PC) polar code may be implemented. FIG. 2B is an example of a PC polar code. A difference between a PC polar code and a regular polar code may be that a subset of the frozen sub-channel set may be selected as one or more PC-frozen sub-channels. Over a PC-frozen sub-channel, a PC function may be established. For example, a PC function may be established for error correction. At a parity check sub-channel position, decoded bits involved in the PC function over the PC-frozen sub-channel may prune the list decoding tree. For example, the paths that may meet the PC function may survive and/or the remaining paths may be eliminated (e.g., eliminated on the fly). A PC function may be established as forward-only. For example, a PC function may be established as forward-only to be consistent with a successive cancellation-based decoder.

Polar codes may be implemented with puncturing and/or rate matching. For example, the output of a polar encoder may be a power of 2, which may impose the restriction of polar codes. The length of information bits (K) and/or the coding rate (R) may be predetermined. Codeword block length may be determined as

$$\frac{K}{R} ,$$

which may not be a power of 2. Puncturing of the output bits may be executed from the smallest number larger than

$$R = \frac{1}{3} ,$$

which may be a power of 2. In an example where K=100 bits and

$$\frac{K}{R} ,$$

the output codeword length may be 300 bits. In an example, 512 bits may be generated from a polar encoder and 212 bits may be punctured from the 512 bits to reach 300 bits.

Polar coding may be non-universal. Codes (e.g., most codes) in coding theory may be universal in the sense that their definition may be independent of channel SNR. Polar codes may be different given a suboptimal, low-complexity, successive cancellation decoding algorithm, or the like. A polar code construction may determine locations of the set of frozen bits. For example, a polar code construction may determine locations of the set of frozen bits so that the resulting block error rate (BLER) may be minimized under a decoding algorithm (e.g., proper decoding algorithm). A Polar code may change with a design SNR. For example, a Polar code may change with a design SNR, given that BLER may be a function of channel SNR. Polar codes generated from different design SNRs may have performance differences for a bit channel reliability calculation scheme.

A channel between a transmitter and receiver may have time-varying conditions. A polar code constructed at a time unit may have degraded performance at another (e.g., the next) time unit. For example, a polar code constructed at a time unit may have degraded performance at the next time unit due to changes in channel conditions. An adaptive system may maintain consistency of polar coding performance.

Puncturing schemes for polar codes may include a quasi-uniform puncturing (QUP) scheme and/or a weight-1 column reduction puncturing (WCRP) scheme.

Polar codes may be capacity-achieving codes. For example, polar codes may be capacity-achieving codes, such as turbo codes and/or LDPC codes. Polar encoding and/or decoding sub-systems may be provided for communication systems equipped with polar coding, which may have a non-universal property that may be different from communication systems equipped with turbo coding and/or LDPC coding.

Adaptive polar codes may be provided. For example, a channel SNR-based adaptive polar coding system may achieve better performance under different channel conditions.

Design SNR may affect reliabilities, rankings of bit channels, and/or the amount of performance difference resulting therefrom. For example, polar code construction of the Bhattacharyya bound may be expressed as follows:

```
Given N, K, and design SNR (dSNR) in linear scale
Initialize z[0] = . . . = z[N − 1] = e^{-dSNR}.
for j = 1: log₂ N
  u = 2^{j};
  $for t = 0 \text{:} \frac{u}{2} - 1$
    z[t] = (2 − z[t]) · z[t];
    $z [ \frac{u}{2} + t ] = z [ t ] \cdot z [ t ] ;$
  end
end
Frozen set [symbol]  is the locations of the N − K greatest elements in
z[0], . . . , z[N − 1].
```

In an example where N=8 and design SNR is 0 dB, reverse reliability calculated from the above pseudo codes may be given by:

z[0:7]=[0.9745, 0.7062, 0.5911, 0.1300, 0.4410, 0.0637, 0.0363, 0.0003].

In an example where design SNR is set as 3 dB, reverse reliability calculated from the above pseudo codes may be given by:

z[0:7]=[0.6894, 0.1960, 0.1244, 0.0041, 0.0719, 0.0013, 0.0007, 0.0000].

A comparison of reverse reliability based on design SNR of 0 dB and 3 dB may demonstrate that differences in design SNR (e.g., 0 dB or 3 dB) may affect reliabilities and/or the ranks of bit channels.

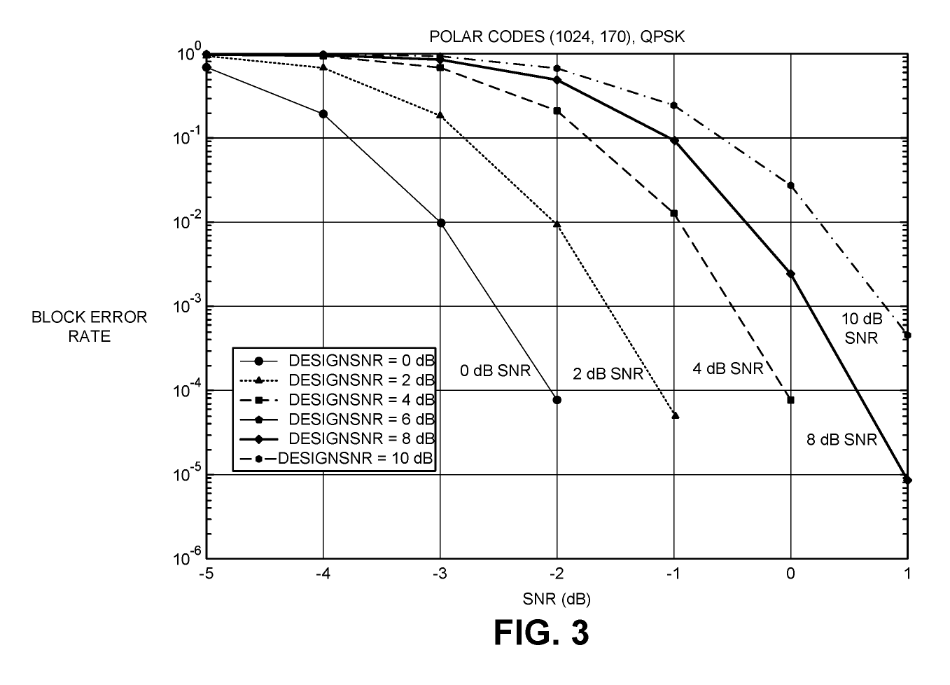

FIG. 3 is an example of BLER with different design SNR for polar coding. FIG. 3 shows a simulated BLER performance of polar codes resulting from different design SNRs. Simulations may be based on an AWGN channel and/or QPSK modulations. For example, a polar code based on Bhattacharyya bounds may be constructed with coded block length N=1024 and/or coding rate

$$R = \frac{1}{6} .$$

Examples shown in FIG. 3 demonstrate that more than 3 dB gain may be obtained at a target BLER level of 1%. For example, more than 3 dB gain may be obtained at a target BLER level of 1% by selecting an appropriate design SNR (e.g., a design SNR that provides more than 3 dB gain at a target BLER level of 1%).

A channel-SNR based adaptive polar coding system may be implemented. In an example, a polar code may be used in a communication system. An operating SNR range of the polar code may be (SNRₘᵢₙ, SNRₘₐₓ). The operating range may be partitioned into subsets. For example, the operating range may be partitioned as follows: (SNRₘᵢₙ, SNR₁), (SNR, SNR₂), . . . , (SNRₙ₋₁, SNRₘₐₓ). A design SNR (e.g., optimal design SNR) may be determined for a subset (e.g., each subset). For example, (dSNR₀, dSNR₁, . . . , dSNRₙ₋₁) may be determined for a subset. There may be a one-to-one correspondence between the SNR range subset and the design SNR. For example, the SNR range subset (SNRᵢ, SNRᵢ₊₁) may correspond to the design SNR as dSNRᵢ.

A design SNR of polar codes in a communication system may change with time. For example, a design SNR of polar codes in a communication system may change with time, e.g., depending on a real time channel condition and/or decoding performance.

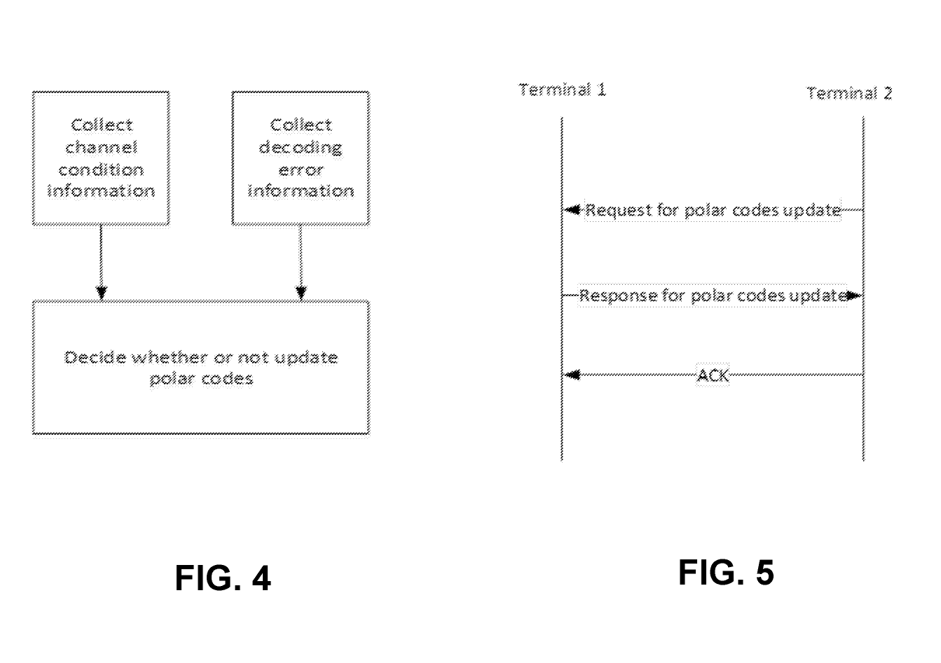

FIG. 4 is an example of a decision making that may be implemented at a transmitter (Tx) and/or a receiver (Rx). In an example for making a decision whether to change a design SNR, a receiver may measure (e.g., continually measure) a channel SNR and/or may track decoding errors (e.g., continually track decoding errors). A receiver may determine whether to update a design SNR based on criteria. For example, a current polar code may be based on dSNRᵢ, which may correspond to SNR range subset (SNRᵢ, SNRᵢ₊₁). Examples of criteria to change a design SNR (e.g., that may be implemented alone or in combination) may include one or more of the following.

The criteria may include a current channel SNR that is more than a predefined number of dB beyond an SNR range corresponding to a current design-SNR. For example, current channel SNR>SNRᵢ₊ₓ+X₁ dB or channel SNR<SNRᵢ−X₂ dB, for some X₁ and X₂. Design SNR may be adjusted based on criteria. An example may be described by pseudo code. For example, three design SNR values may be proposed as dSNR₀, dSNR₁ and dSNR₂ in a lookup table. A current design SNR value may be dSNR₁. Example pseudocode may be:
IF channel SNR belongs to [SNR₁−X₂,SNR₂+X₁],
   designSNR=dSNR₁
ELSE IF channel SNR>SNR₂+X₁
   designSNR=dSNR₂
ELSE IF channel SNR<SNR₁−X₂
   designSNR=dSNR₀

The criteria may include that a current channel SNR may follow in the SNR range (SNRⱼ, SNRⱼ₊₁), where j>i+Y₁ or j<i−Y₂, for some Y₁ and Y₂. A design SNR may be adjusted, for example, based on the criteria.

The criteria may include that a current channel SNR may be more than a predefined number of dB beyond the SNR range corresponding to the current design-SNR. Z number of decoding errors may have occurred in the past T time units occurs. A design SNR may be adjusted, for example, based on the criteria.

A transmitter may receive a channel SNR (e.g., via feedback) from a receiver in an FDD system and/or from a measurement in a TDD system. A transmitter may (e.g., in an FDD system) receive channel SNR information in CQI feedback and/or may receive explicit channel SNR information, e.g., dedicated for a polar coding application. A transmitter may receive decoding error information from a receiver. For example, a transmitter may receive decoding error information from a receiver via ACK/NACK feedback.

A terminal may be a transmitter and/or receiver. A terminal may determine to update polar codes. For example, a terminal may determine to update polar codes at the end of a decision making, such as the example shown in FIG. 4. A terminal may initiate a message flow. An example message flow is shown in FIG. 5.

FIG. 5 is an example of a message flow for polar code updates. A terminal may send a request for a polar code update.

A message content may include an existing dSNR index, a new/updated dSNR index, and/or a starting time for the update.

A message content may include a delta value of the dSNR index change and/or a starting time for the update. A delta value may be +1, which may indicate a move from index i to index i+1, or −1, which may indicate a move from index i to index i−1, etc.

A terminal receiving a request may determine whether to accept a polar code update. A response may be sent to indicate acceptance or rejection of a proposed polar code in an update request. A terminal receiving the indication may send an ACK or NACK to confirm agreement or disagreement with a decision.

A design SNR may be adjusted. For example, a design SNR may be adjusted based on an equalizer type. An advanced equalizer may improve measured SNR and/or BLER performance at a receiver. A design SNR may be optimized based on an equalizer type, for example, based on an advanced equalizer.

A polar code may be designed as decoder-aware channel encoding at a transmitter. One or more decoders may result in a non-universal polar code. One or more decoders (e.g., an ML decoder) may result in a universal polar code.

An SNR-independent polar code construction may be used. An SNR-independent polar code construction may be based on the weight sequences of the generator matrix. An SNR-independent polar code construction may sacrifice BLER performance. The use of SNR-independent polar code construction may be used in communication systems where reducing complexity may be important. For example, the use of SNR-independent polar code construction may be used in communication systems where reducing complexity may be more important than performance. The use of SNR-independent polar code construction may be used in communication systems for low cost devices and/or for users with low QoS requirements.

Although the polar code described herein may adjust the design SNR according to one or more factors, the polar code may not be restricted to design SNR. Other parameters of constructing polar code may be contemplated and/or may be implemented using the concepts described herein.

Advanced rate matching schemes for polar codes may achieve better performance. Schemes for polar codes may include, for example, a quasi-uniform puncturing (QUP) scheme and/or a weight-1 column reduction (WCR) scheme.

Polar code puncturing may be represented by a puncturing vector P=(p₁ . . . , p_{N}), where Pᵢ∈{0,1}, “0” may indicate punctured positions. In an example, M bits may be punctured from N output bits from a polar encoder.

A quasi-uniform puncturing scheme may initialize a puncturing vector. For example, a quasi-uniform puncturing scheme may initialize a puncturing vector as ones (e.g., all ones). A quasi-uniform puncturing scheme may set bits of the vector (e.g., the first M bits of the vector) as zeros. A bit-reversal permutation may be performed on the vector P to obtain the puncturing vector.

QUP may be configured to maximize the minimum Hamming distance. The minimum Hamming distance resulting from QUP may be larger than the minimum Hamming distance resulting from random puncturing.

Puncturing position selection may correlate with frozen bits selection. For example, QUP schemes may be applied on top of polar code constructions with the Bhattacharyya bounds. Example code constructions may be shown by pseudo-code.

A first example QUP scheme may be referred to as QUP scheme 1:

```
Given N, K, and design SNR (dSNR) in linear scale
Initialize z[0]= . . . = z[M − 1] = 1 − δ, for some δ ≥ 0.
Initialize z[M] = . . . = z[N − 1] = e^{-dSNR}.
for j = 1: log₂ N
  u = 2^{j};
  $for t = 0 \text{:} \frac{u}{2} - 1$
    z[t] = (2 − z[t]) · z[t];
    $z [ \frac{u}{2} + t ] = z [ t ] \cdot z [ t ] ;$
  end
end
Frozen set [symbol]  is the locations of the N − K greatest elements in
z[0], . . . , z[N − 1].
```

An example polar code construction may associate Bhattacharyya bounds with a QUP puncturing scheme.

A second example QUP scheme may be referred to as QUP scheme 2:

```
Given N, K, and design SNR (dSNR) in linear scale
Initialize z[0] = . . . = z[N − 1] = e^{-dSNR}.
for j = 1: log₂ N
  u = 2^{j};
  $for t = 0 \text{:} \frac{u}{2} - 1$
    z[t] = (2 − z[t]) · z[t];
    $z [ \frac{u}{2} + t ] = z [ t ] \cdot z [ t ] ;$
  end
end
z[0] = . . . = z[M − 1] = 1 + δ, for some δ ≥ 0.
Frozen set [symbol]  is the locations of the N − K greatest elements in
z[0], . . . , z[N − 1].
```

In example code construction schemes (e.g., QUP scheme 2), the first M input bits to a polar encoder may be (e.g., always) frozen bits. The frozen bits may correspond to less reliable bit channels.

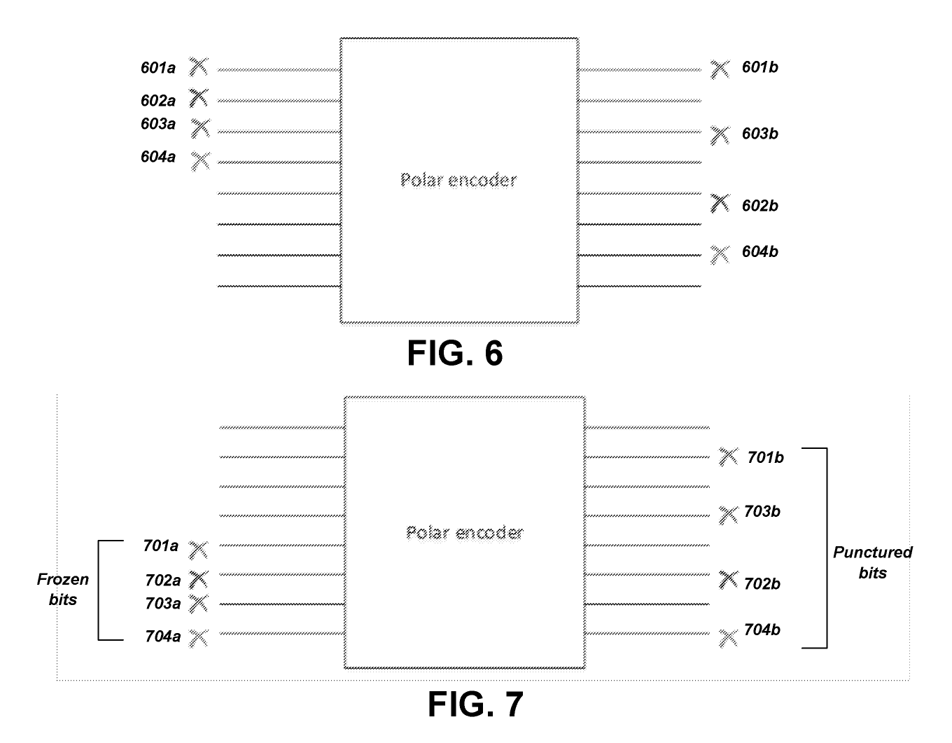

FIG. 6 is an example of quasi-uniform puncturing scheme 2. FIG. 6 illustrates an example of QUP scheme 2 for N=8, M=4. Four bits may be punctured based on a quasi-uniform scheme. For example, the bit indicated by 601a may be punctured to a bit indicated by 601b; the bit indicated by 602a may be punctured to a bit indicated by 602b; the bit indicated by 603a may be punctured to a bit indicated by 603b; and/or the bit indicated by 604a may be punctured to a bit indicated by 604b. The bits may be punctured based on a quasi-uniform scheme. Punctured positions may be uniform (e.g., roughly uniform).

A difference between QUP scheme 2 versus QUP scheme 1 may be that QUP scheme 2's code construction may not rely on the puncturing pattern. In QUP scheme 2, code construction may be performed beforehand. For example, in QUP scheme 2, code construction may be performed without considering puncturing pattern. The puncturing pattern may be executed after the code construction is complete. The underlined operations in QUP scheme 2 pseudo-codes (e.g., applying the update from the original Bhattacharyya bound-based polar code construction) may be at the end of the pseudo-codes. In the QUP scheme 1, the underlined operations in QUP scheme 1 pseudo-codes may be at the beginning of the pseudo-codes.

In an example of a weight-1 column reduction scheme, an example generator matrix G_{N} may be provided:
for i=1: M
   Calculate the weight of each column
   Choose one column with column weight 1. This column index i is such that pᵢ=0.
   Delete the column and the row corresponding to the position of “1”
end

A puncturing vector may be determined from generator matrix G_{N} of a polar code. An index of a weight-1 column in G_{N} may be selected as a puncturing position (e.g., pᵢ=0). The column and row corresponding to the 1's location may be deleted/removed from generator matrix G_{N}. Deleting/removing the column and row corresponding to the 1's location from generator matrix G_{N} may reduce the matrix dimension from N×N to (N−1)×(N−1). The new/reduced matrix for the remaining M−1 puncturing positions may continue in the same manner.

A weight-1 column of G_{N} may indicate a one-to-one mapping between the input bit and corresponding output bit of a polar encoder. For example, an output bit associated with an input bit may be equal to 0 when the input bit corresponding to a weight-1 column of G_{N} is set to 0.

Code construction for a weight-1 column reduction puncturing scheme may involve setting an input bit corresponding to a weight-1 column as a frozen bit (e.g., 0). Setting an input bit corresponding to a weight-1 column as a frozen bit may indicate that the associated output bit may be equal to 0. Puncturing on the output position may retain information (e.g., may not lose information) for a decoder. The decoder may determine that the punctured bit is 0 (e.g., always 0). A priori information may improve polar decoding performance. A Log-Likelihood Ratio (LLR) for the punctured bits at the decoding may be set as infinity.

A weight-1 column reduction scheme may not lead to a unique puncturing vector. There may exist more than one weight-1 column within a (e.g., each) loop of a matrix reduction. Different choices may be made on a weight-1 column selection.

A selection of weight-1 columns may be the last M columns of the F₂^{⊗n}. The selection may indicate that the puncturing vector P may be the bit-reversal permutation on the N-bit vector, for example, with the last M bits being zeros and/or the remaining N−M bits being ones. An example may be shown in FIG. 7.

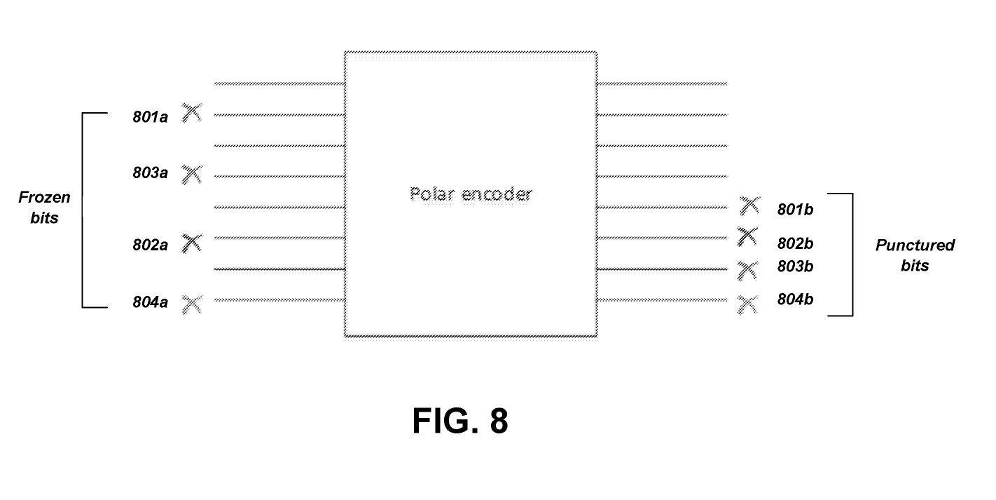

A selection of weight-1 columns may be the puncturing vector P as the N-bit vector. For example, a selection of weight-1 columns may be the puncturing vector P as the N-bit vector, with the last M bits being zeros and/or the remaining N−M bits being ones. An example may be shown in FIG. 8.

A weight-1 column reduction puncturing scheme (e.g., like a QUP puncturing scheme) may be related to a polar code construction and/or a frozen bits selection. For example, weight-1 column reduction puncturing schemes may be applied on top of polar code constructions with the Bhattacharyya bounds. An example code construction presented in pseudo-code may be referred to as weight-1 column reduction scheme 1:

```
Given N, K, and design SNR (dSNR) in linear scale
Initialize z[0] = . . . = z[N − 1] = e^{-dSNR}.
for j = 1: log₂ N
  u = 2^{j};
  $for t = \text{0:} \frac{u}{2} - 1$
    z[t] = (2 − z[t]) · z[t];
    $z [ \frac{u}{2} + t ] = z [ t ] \cdot z [ t ] ;$
  end
end
z[N − M] = . . . = z[N − 1] = 1 + δ, for some δ ≥ 0.
Frozen set [symbol]   is the locations of the N − K greatest elements in z[0], . . . ,
z[N − 1].
```

FIG. 7 is an example of a weight-1 column reduction scheme 1. FIG. 7 illustrates an example where N=8, M=4. In an example, four bits may be punctured based on a weight-1 column reduction scheme. For example, a frozen bit indicated by 701a may be punctured to a bit indicated by 701b; a frozen bit indicated by 702a may be punctured to a bit indicated by 702b; a frozen bit indicated by 703a may be punctured to a bit indicated by 703b; and/or a frozen bit indicated by 704a may be punctured to a bit indicated by 704b. The bits may be punctured based on a weight-1 column reduction scheme.

An example code construction presented in pseudo-code may be referred to as weight-1 column reduction scheme 2:

```
Given N, K, and design SNR (dSNR) in linear scale
Initialize z[0] = . . . = z[N − 1] = e^{-dSNR}.
for j = 1: log₂ N
  u = 2^{j};
  $for t = \text{0:} \frac{u}{2} - 1$
    z[t] = (2 − z[t]) · z[t];
    $z [ \frac{u}{2} + t ] = z [ t ] \cdot z [ t ] ;$
  end
end
z[BR(N − M)] = . . . = z[BR(N − 1)] = 1 + δ, for some δ ≥ 0 and BR is the bit
reverse operation.
Frozen set [symbol]   is the locations of the N − K greatest elements in z[0], . . . ,
z[N − 1].
```

FIG. 8 is an example of a weight-1 column reduction scheme 2. FIG. 8 illustrates an example where N=8, M=4. In an example, four bits may be punctured based on a weight-1 column reduction scheme. For example, a frozen bit indicated by 801a may be punctured to a bit indicated by 801b; a frozen bit indicated by 802a may be punctured to a bit indicated by 802b, a frozen bit indicated by 803a may be punctured to a bit indicated by 803b, and/or a frozen bit indicated by 804a may be punctured to a bit indicated by 804b. The bits may be punctured based on a weight-1 column reduction scheme.

Pseudo-codes for QUP schemes and/or weight-1 column reduction schemes, as described herein, may be exemplified using the Bhattacharyya bound-based polar code. Puncturing schemes and/or operations may apply to one or more (e.g., one or more other) polar codes (and/or polar code construction schemes). Examples of polar codes (and/or polar code construction schemes) may include Monte-Carlo estimation polar codes, Gaussian approximation polar codes, full transition probability matrices estimation polar codes, etc.

Puncturing schemes may be applied to Parity Check (PC) polar codes. In PC polar codes, one or more frozen bits may be used as PC frozen bits. PC frozen bits may equal, and/or may be derived from, information bits. Input channels associated with punctured bits may be set by a lowest reliability. For example, input channels associated with punctured bits may be set by a lowest reliability so that the input channels may be used for frozen bits. Input channels associated with punctured bits may be used for frozen bits in PC polar codes. Beyond the input channels associated with punctured bits, the information bits, PC frozen bits, and/or other frozen bits may be assigned. Pseudo-codes (e.g., QUP schemes 1 and 2, weight-1 column reduction scheme 1 and 2, described herein) may be modified. The values for “z[ ]” may be set (e.g., explicitly set). Input channels associated with punctured bits may be marked. At the end of a code construction, the marked input channels may be set as frozen bits. In PC polar code construction, the information of the input channels associated with punctured bits may be used to determine the remaining frozen bits, PC-frozen bits, and information bits. For example, for PC polar codes, the following pseudo-codes may be modified (on lines 11 and 12) from QUP scheme 2.

| | |
|---|---|
| 1. | Given N, K, and design SNR (dSNR) in linear scale |
| 2. | Initialize z[0] = . . . = z[N − 1] = e^{-dSNR}. |
| 3. | for j = 1: log₂ N |
| 4. | u = 2^{j}; |
| 5. | $for t = 0 \text{:} \frac{u}{2} - 1$ |
| 6. | z[t] = (2 − z[t]) · z[t]; |
| 7. | $z [ \frac{u}{2} + t ] = z [ t ] \cdot z [ t ] ;$ |
| 8. | end |
| 9. | end |
| 10. | z[0] = . . . = z[M − 1] = 1 + δ, for some δ ≥ 0. |
| 11. | The M greatest elements in z[0], . . . , z[N − 1] may |
| | belong to Frozen set. |
| 12. | Determine the information bits set, the PC-frozen bits set, and the |
| | remaining frozen bits sets based on the reliability ranking of z. |

For example, for PC polar codes, the following pseudo-codes may be modified (on lines 11 and 12) from weight-1 column reduction scheme 2.

| | |
|---|---|
| 1. | Given N, K, and design SNR (dSNR) in linear scale |
| 2. | Initialize z[0] = . . . = z[N − 1] = e^{-dSNR}. |
| 3. | for j = 1: log₂ N |
| 4. | u = 2^{j}; |
| 5. | $for t = 0 \text{:} \frac{u}{2} - 1$ |
| 6. | z[t] = (2 − z[t]) · z[t]; |
| 7. | $z [ \frac{u}{2} + t ] = z [ t ] \cdot z [ t ] ;$ |
| 8. | end |
| 9. | end |
| 10. | z[BR(N − M)] = . . . = z[BR(N − 1)] = 1 + δ, for some δ ≥ 0 and BR |
| | is the bit reverse operation. |
| 11. | The M greatest elements in z[0], . . . , z[N − 1] |
| | may belong to Frozen set. |
| 12. | Determine the information bits set, the PC-frozen bits set, and the |
| | remaining frozen bits sets based on the reliability ranking of z. |

In the above pseudo-code, Steps 1-9 may be replaced by code construction schemes. For example, Steps 1-9 may be replaced by code construction schemes, including SNR-independent code constructions. A compromise with respect to performance may be used with the SNR-independent construction schemes.

Example results are shown for one or more example puncturing schemes. Examples may be based on a N=1024, K=256 polar code constructed with Bhattacharyya bounds, a CRC-aided list-4 decoding algorithm, QPSK modulation, and/or AWGN channel.

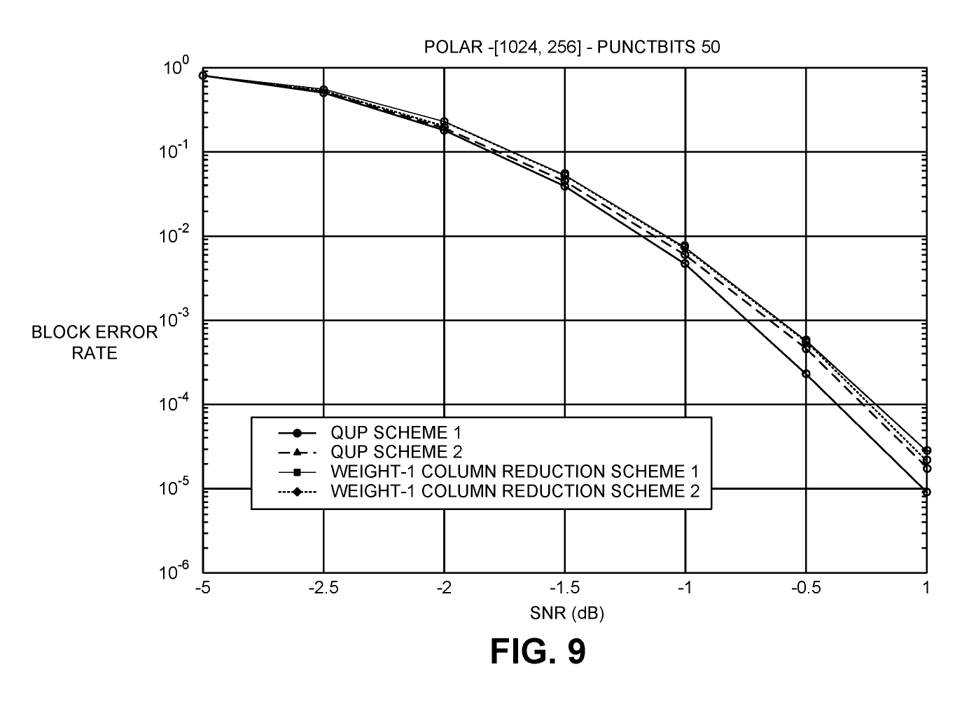

FIG. 9 is an example of puncturing scheme performance where 50 bits are punctured. FIG. 9 shows BLER performance for one or more examples of puncturing schemes when 50 bits are punctured from polar encoder outputs. QUP scheme 1 may provide the best performance.

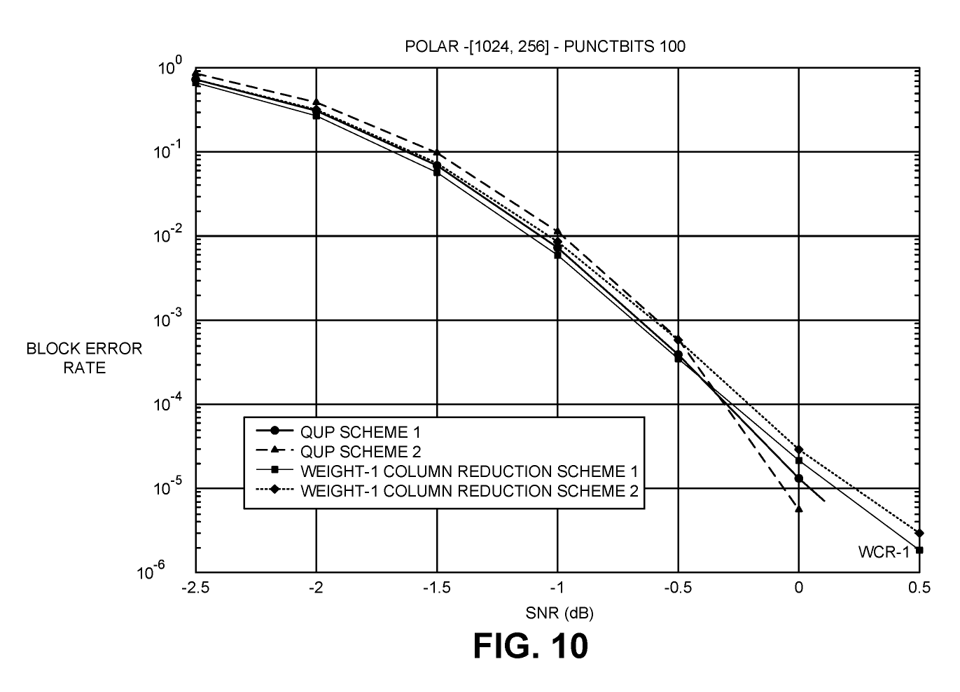

FIG. 10 is an example of puncturing scheme performance where 100 bits are punctured. FIG. 10 shows BLER performance for one or more examples of puncturing schemes when 100 bits are punctured from polar encoder outputs. QUP scheme 1 and weight-1 column reduction scheme 1 may provide the best performance. A weight-1 column reduction scheme may be referred to as a weight-1 column reduction puncturing scheme.

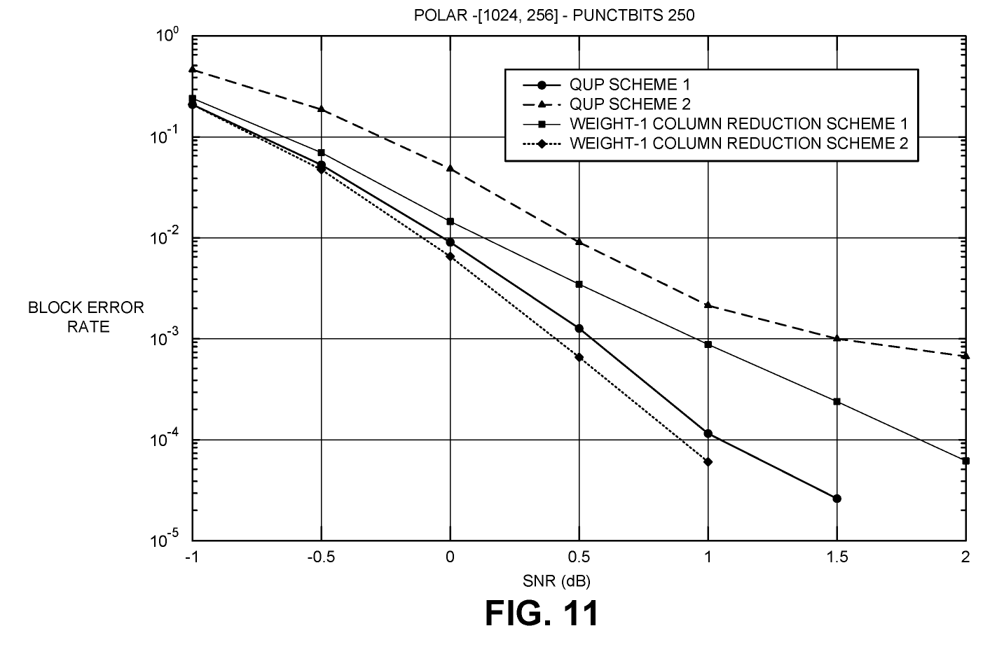

FIG. 11 is an example of puncturing scheme performance where 250 bits are punctured. FIG. 11 shows BLER performance for one or more examples of puncturing schemes when 250 bits are punctured from polar encoder outputs. Weight-1 column reduction scheme 2 may provide the best performance.

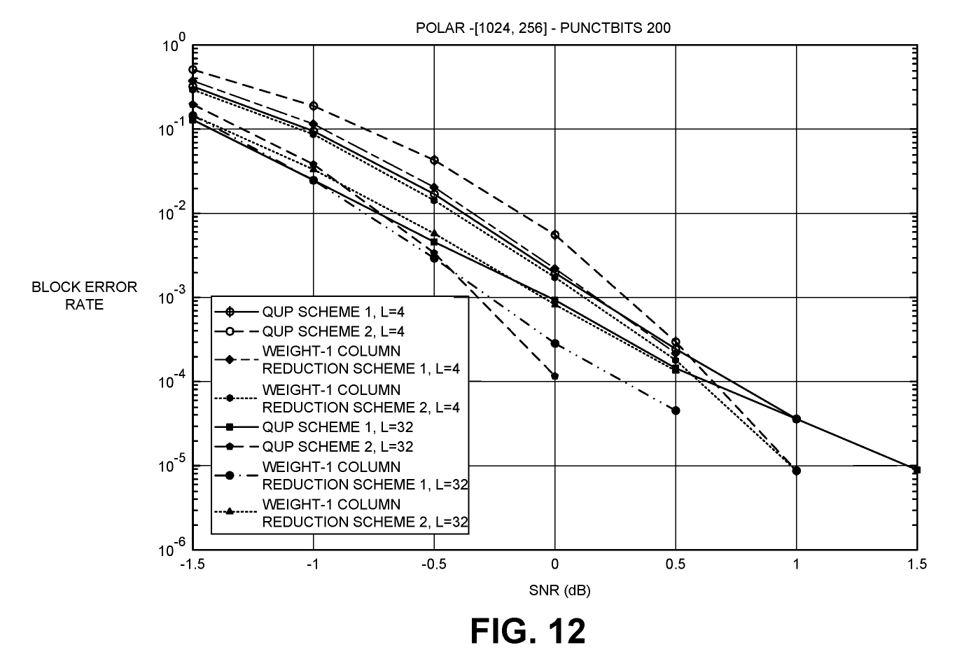

FIG. 12 is an example puncturing scheme performance where 200 bits are punctured at list 4 and list 32. FIG. 12 shows BLER performance for one or more examples of puncturing schemes when 200 bits are punctured from polar encoder outputs.

Puncturing schemes may have different performances, for example, under different conditions.

Different puncturing schemes may provide different levels of performance for different numbers of punctured bits.

Different puncturing schemes may have different performances under different decoding algorithms. In an example (e.g., as shown in FIG. 12), a weight-1 column reduction scheme 2 may have the best performance when list-4 decoding is applied. A QUP scheme 2 may have the best performance when list-32 decoding is applied.

Hybrid puncturing schemes may be used. A puncturing scheme may mix a quasi-uniform scheme and a weight-1 column reduction scheme. M bits to be punctured may be separated, for example, as MR, 0≤R≤1 bits to be punctured using a quasi-uniform scheme and M(1−R) bits to be punctured using a weight-1 column reduction scheme. An example hybrid scheme may be a quasi-uniform scheme, for example, when rate R is 0. The example hybrid scheme may be a weight-1 column reduction scheme, for example, when rate R is 1.

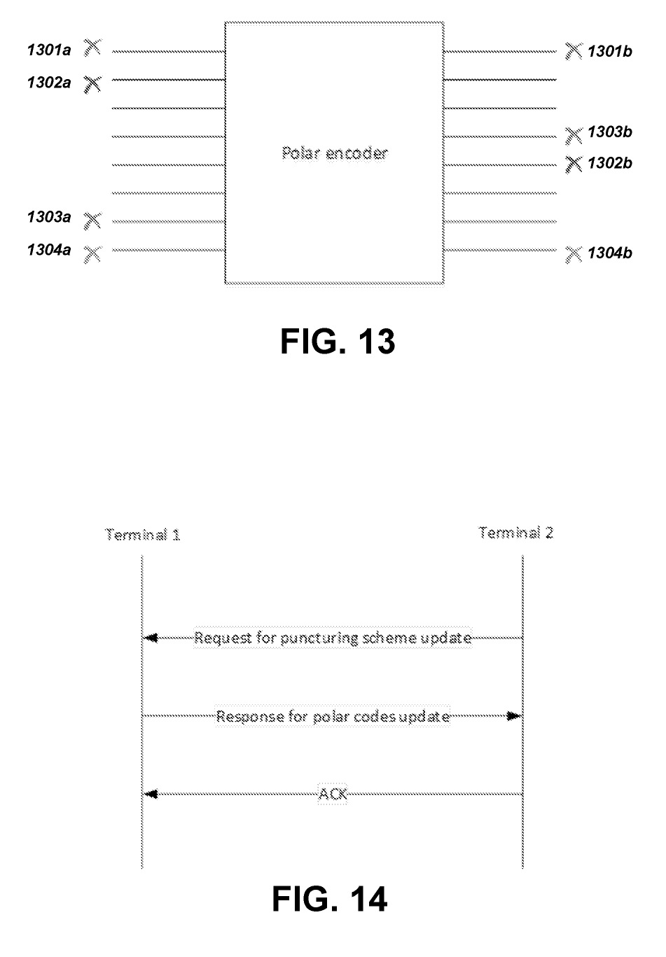

FIG. 13 is an example of a hybrid puncturing scheme. FIG. 13 illustrates an example of a hybrid scheme for N=8, M=4 and

$$R = \frac{1}{2} .$$

Two bits may be punctured based on a quasi-uniform scheme. For example, a bit indicated by 1301a may be punctured to a bit indicated by 1301b; and a bit indicated by 1302a may be punctured to a bit indicated by 1302b. Two bits may be punctured based on a weight-1 column reduction scheme. For example, a bit indicated by 1303a may be punctured to a bit indicated by 1303b; and a bit indicated by 1304a may be punctured to a bit indicated by 1304b.

Polar codes may have a non-universality property. Polar codes may update code constructions. For example, polar codes may update code constructions due to changes in channel conditions. A puncturing scheme may affect polar code construction (e.g., frozen bit selection). A puncturing scheme may vary, for example, due to changes in channel conditions. Communication between transmitter and receiver may synchronize a puncturing scheme.

A terminal (e.g., transmitter or receiver) may update a puncturing scheme, which may initiate a message flow, e.g., as in FIG. 14.

FIG. 14 is an example message flow for polar code puncturing scheme updates. A request may be made (e.g., may be made in the form of a message) for a puncturing scheme update. Message contents may include a puncturing scheme index. Table 1 provides an example of a puncturing scheme index.

TABLE 1

| Puncturing | |
|---|---|
| scheme index | Puncturing scheme |
| 1 | Quasi-uniform puncturing |
| 2 | Weight-1 column reduction puncturing |
| 3 | Mixture of quasi-uniform puncturing and weight-1 |
| | column reduction puncturing |

Message contents may include one or more parameters for a puncturing scheme. For example, a weight-1 column reduction scheme may have implementations that may be described by various parameters and/or values. The parameters and/or values may specify an implementation. For example, parameters for a mixture puncturing scheme may specify a ratio of the puncturing bits for quasi-uniform scheme, etc.

A terminal receiving a request may determine whether to accept or reject a puncturing scheme update. A response may be sent with an indication of acceptance or rejection of the request. An ACK or NACK may be provided by the requesting terminal. An ACK may confirm agreement or disagreement with acceptance or rejection. An update to a puncturing scheme may be combined with a design SNR update.

Puncturing bits (e.g., common puncturing bits) may be selected by one or more puncturing schemes (e.g., a device implementing the puncturing scheme). Puncturing rates for puncturing schemes may be increased, for example, based on selecting puncturing bits via one or more puncturing schemes.

QUP schemes and weight-1 column reduction schemes may be combined. For example, QUP schemes and/or weight-1 column reduction schemes may be combined in a polar encoding (e.g., a single polar encoding). QUP schemes and/or weight-1 column reduction schemes may be combined via one or more polar encodings. As shown in the examples provided in FIGS. 9-12, the performance of QUP schemes and/or weight-1 column reduction schemes may vary (e.g., may vary under different conditions). For example, the performance of QUP schemes and/or weight-1 column reduction schemes may vary based on code block lengths, the number of punctured bits (e.g., the punctured length), effective code rates, polar decodings, etc. The performance of a puncturing scheme may be enhanced under one or more sets of conditions. A puncturing scheme may be selected depending on one or more of the following conditions, in any combination: a channel condition, an information block length, a code block length, number of punctured bits (e.g., punctured length), a coding rate (e.g., an effective coding rate), and/or a polar decoding algorithm.

A code construction for one or more component polar codes (e.g., multiple component polar codes) may be used. A codeword length of a polar code may be a factor of 2. A coded block size may be larger than 2ⁿ. If a coded block size is larger than 2ⁿ, the polar code may be applied with a length 2ⁿ⁺¹, and/or bits may be punctured, e.g., to match a predefined coded block size. Puncturing bits to match a predefined coded block size may degrade the performance of polar codes.

A combination mechanism may be provided. A polar code may achieve the rate matching purpose via the combination mechanism. Via the combination mechanism, one or more polar codes (e.g., small size polar codes) may be used in combination, e.g., to achieve a predefined coded block size.

For example, if the desired coded block size is 20, 12 bits from the polar code may be punctured with block length 32 (=2⁵). A 16-bit polar code and a 4-bit polar code may be used to achieve the 20 bits coded block.

Rate matching mechanisms (e.g., the puncturing mechanism and/or the combination mechanism) may be switched. For example, rate matching mechanisms may be switched based on the rate matching mechanism's performance under different conditions. If the number of punctured bits is smaller than X bits, and/or if the ratio of puncturing is less than Y/2ⁿ (e.g., where 2ⁿ is the codeword length of a polar code), the puncturing mechanism may be used. If the number of punctured bits is larger than X bits, and/or if the ratio of puncturing is greater than Y/2ⁿ, the combination mechanism may be used. The selection of a rate matching mechanism may depend on one or more of the following, in any combination. Information block length, coded block length, decoding algorithm, and/or polar code type (e.g., construction type). The switch between the rate mechanisms may depend on the rate matching mechanism's performance. The switch between the rate mechanisms may vary. For example, the switch between the rate mechanisms may vary with time.

In a combination mechanism, multiple polar codes may be used. Mapping from information bits to the bit channels may be re-designed in a combination mechanism. For example, re-designed mapping may allow one or more (e.g., each) component polar codes in the combination mechanism to have information bits to encode.

Assignment of information bits to multiple component polar codes may depend on the reliabilities of bit channels. For example, a reverse reliability of a N=8 polar code with design SNR 0 dB may be given by:

z[0:7]=[0.9745, 0.7062, 0.5911, 0.1300, 0.4410, 0.0637, 0.0363, 0.0003].

A reverse reliability of a N=4 polar code with design SNR 0 dB may be given by:

z[0:3]=[0.8403, 0.3605, 0.2523, 0.0183].

A combined rank over the two polar codes may be expressed as U₇⁸, U₃⁴, U₆⁸, U₅⁸, U₃⁸, U₂⁴, U₁⁴, U₄⁸, U₂⁸, U₁⁸, U₀⁴, U₀⁸, where Uᵢ⁸ may indicate the i-th bit channel in the N=8 polar code and/or Uᵢ⁴ may indicate the i-th bit channel in the N=4 polar code. Reliabilities among one or more component polar codes may be modified. For example, reliabilities among one or more component polar codes may be modified to achieve better performance. A different design SNR value for the N=4 polar code may be used than used for N=8 polar code.

Assignment of information bits to multiple component polar codes may maximize the minimum Hamming distance of the resulting codeword from one or more component polar codes. For example, a Hamming distance (e.g., the minimum Hamming distance) may be increased by applying XOR operations on information bits. The XOR-ed bits may be put to certain bit channels.

Assignment schemes (e.g., the reliability-based scheme and/or minimum Hamming distance-based scheme) may be applied jointly. For example, the assignment schemes may be applied jointly to achieve improved performance.

Code construction for polar encoding without bit reversal operations may be used. As described herein, the polar encoding may comprise a bit-reversal (BR). For example, the generator matrix of a polar code may be G_{N}=B_{N}F^{⊗n} or G_{N}=F^{⊗n}. (.)^{⊗n} may denote the n-th Kronecker power,

$$F = [ \begin{matrix}1 & 0 \\ 1 & 1\end{matrix} ]$$

and B_{N} may be a bit-reversal.

The code performance may not be affected by the bit-reversal operation B_{N} at the encoder. The bit-reversal operation B_{N} at the encoder may affect the descriptions of the puncturing schemes. The puncturing schemes may be based on the case of bit-reversal operations B_{N} at encoder. Puncturing schemes may be provided for the case without bit-reversal operations.

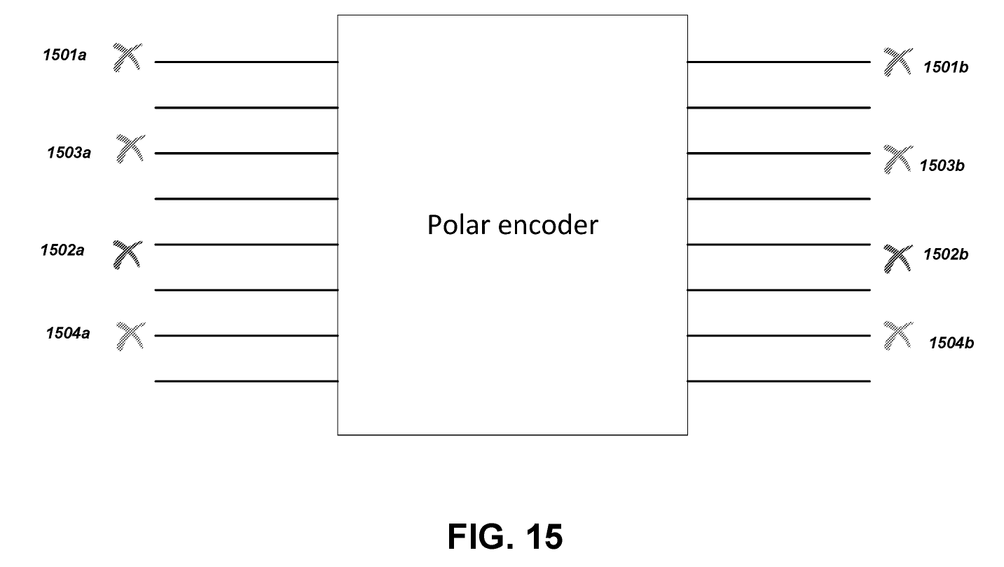

FIG. 6 illustrates an example of a quasi-uniform scheme for N=8, M=4, for encoder BR operations. Example descriptions for the case without encoder BR operations may be shown in FIG. 15. In an example, four bits may be punctured based on a quasi-uniform scheme. For example, bits indicated by 1501a and corresponding 1501b; 1502a and corresponding 1502b; 1503a and corresponding 1503b; and/or 1504a and corresponding 1504b may be punctured based on a quasi-uniform scheme. Bits indicated by 1501b, 1502b, 1503b, and/or 1504b may the punctured bits.

Polar code construction with the Bhattacharyya bounds associated with the QUP puncturing scheme 2 and without encoder BR operation may be as follows.

```
Given N, K, and design SNR (dSNR) in linear scale
Initialize z[0] = . . . = z[N − 1] = e^{-dSNR}.
for j = 1: log₂ N
  u = 2^{j};
  $for t = \text{0:} \frac{u}{2} - 1$
    z[t] = (2 − z[t]) · z[t];
    $z [ \frac{u}{2} + t ] = z [ t ] \cdot z [ t ] ;$
  end
end
z[BR(0)] = . . . = z[BR(M − 1)] = 1 + δ, for some δ ≥ 0 and BR is the bit
reverse operation.
Frozen set [symbol]   is the locations of the N − K greatest elements in z[0], . . . ,
z[N − 1].
```

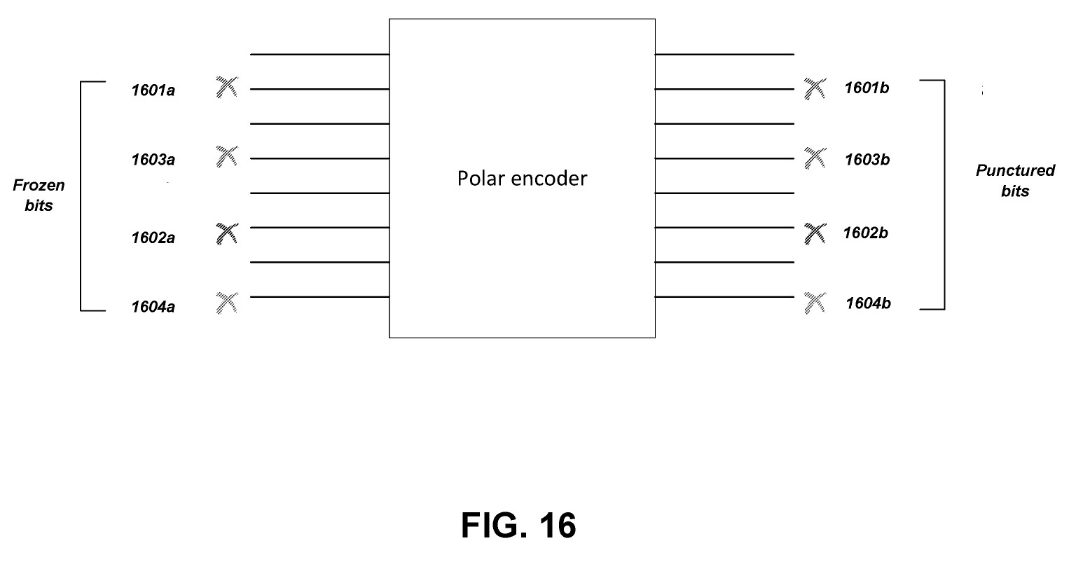

FIG. 7 illustrates an example weight-1 column reduction scheme 1 for the example of N=8, M=4, for the case with encoder BR operations. Example descriptions for the case without encoder BR operation may be shown in FIG. 16. Four bits may be punctured based on a weight-1 column reduction scheme. For example, bits indicated by 1601a and corresponding 1601b; 1602a and corresponding 1602b; 1603a and corresponding 1603b; and/or 1604a and corresponding 1604b may be punctured based on a weight-1 column reduction scheme. Bits indicated by 1601b, 1602b, 1603b, and/or 1604b may the bits punctured from frozen bits 1601a, 1602a, 1603a, and/or 1604a.

The corresponding polar code construction with the Bhattacharyya bounds associated with the Weight-1 column reduction scheme 1 and without encoder BR operation may be as follows.

```
Given N, K, and design SNR (dSNR) in linear scale
Initialize z[0] = . . . = z[N − 1] = e^{-dSNR}.
for j = 1: log₂ N
  u = 2^{j};
  $for t = \text{0:} \frac{u}{2} - 1$
    z[t] = (2 − z[t]) · z[t];
    $z [ \frac{u}{2} + t ] = z [ t ] \cdot z [ t ] ;$
  end
end
z[BR(N − M)] = . . . = z[BR(N − 1)]  =  1 + δ, for some δ ≥ 0 and BR is the bit
reverse operation.
Frozen set [symbol]   is the locations of the N − K greatest elements in z[0], . . . ,
z[N − 1].
```

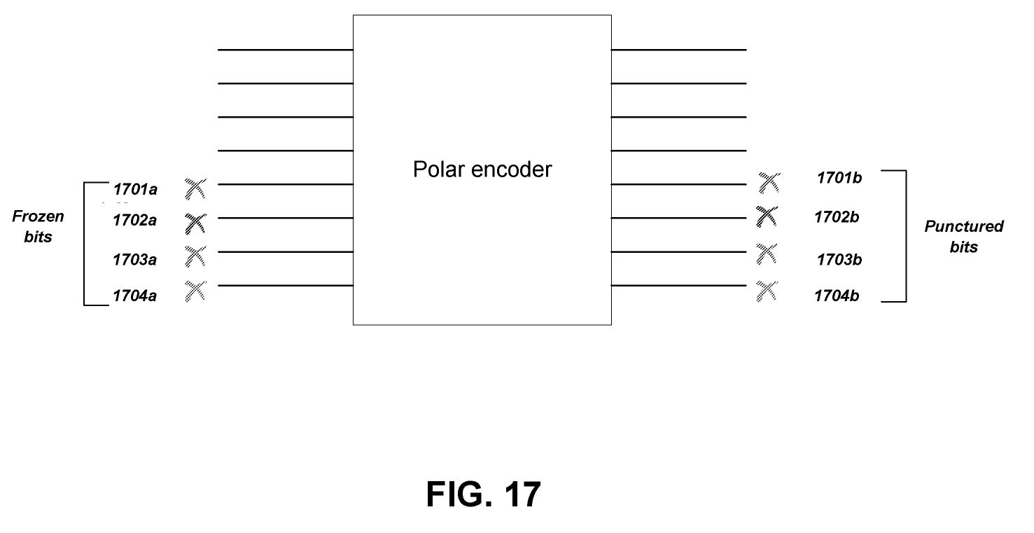

FIG. 8 illustrates an example weight-1 column reduction scheme 2 for the example of N=8, M=4, for the case with encoder BR operations. Example descriptions for the case without encoder BR operation may be shown in FIG. 17. Four bits may be punctured based on a weight-1 column reduction scheme. For example, bits indicated by 1701a and corresponding 1701b; 1702a and corresponding 1702b; 1703a and corresponding 1703b; and/or 1704a and corresponding 1704b may be punctured based on a weight-1 column reduction scheme. Bits indicated by 1701b, 1702b, 1703b, and/or 1704b may the bits punctured from frozen bits 1701a, 1702a, 1703a, and/or 1704a.

The corresponding polar code construction with the Bhattacharyya bounds associated with the Weight-1 column reduction scheme 2 and without encoder BR operation may be as follows.

```
Given N, K, and design SNR (dSNR) in linear scale
Initialize z[0] = . . . = z[N − 1] = e^{-dSNR}.
for j = 1: log₂ N
  u = 2^{j};
  $for t = \text{0:} \frac{u}{2} - 1$
    z[t] = (2 − z[t]) · z[t];
    $z [ \frac{u}{2} + t ] = z [ t ] \cdot z [ t ] ;$
  end
end
z[N − M] = . . . = z[N − 1] = 1 + δ, for some δ ≥ 0.
Frozen set [symbol]   is the locations of the N − K greatest elements in z[0], . . . ,
z[N − 1].
```

FIG. 13 illustrates an example of the mixed puncturing scheme for N=8, M=4, and

$$R = \frac{1}{2} ,$$

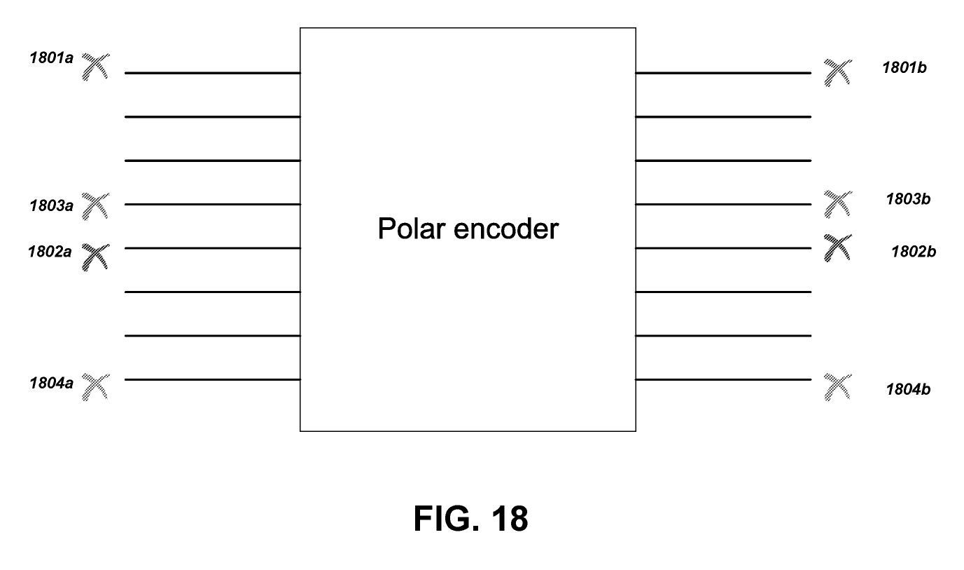

for the case with encoder BR operations. Example descriptions for the case without encoder BR operation are shown in FIG. 18. Two bits may be punctured based on a quasi-uniform scheme. For example, bits indicated by 1801b and/or 1802b may be punctured based on a quasi-uniform scheme. Two bits may be punctured based on a weight-1 column reduction scheme. For example, bits indicated by 1803b and/or 1804b may be punctured based on a weight-1 column reduction scheme.

A mixture of a puncturing scheme may not be restricted to a QUP scheme and/or a weight-1 column reduction scheme. A puncturing scheme to be mixed may include serial puncturing from the top, distributed puncturing from the top and/or the middle for the code blocks, serial weight-1 column reduction from the bottom, etc.

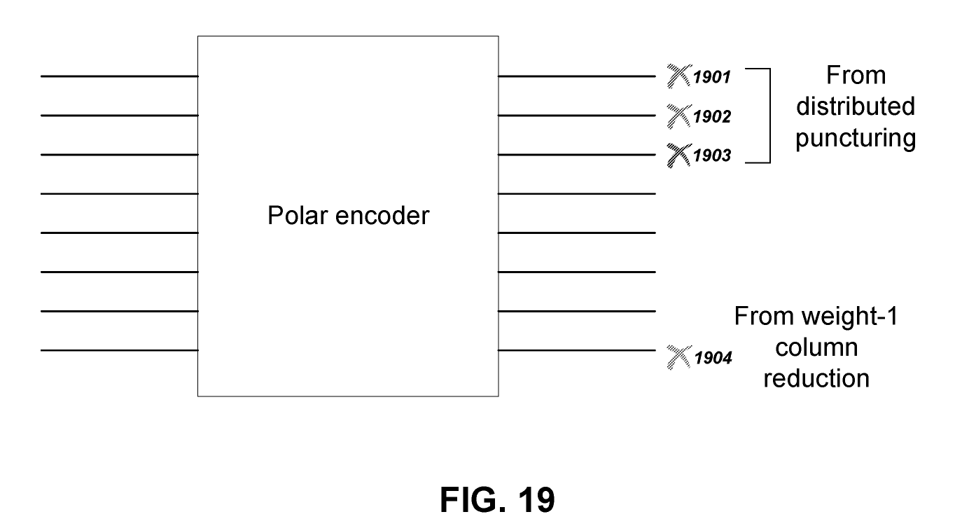

FIG. 19 is an example of a mixed puncturing scheme. A mixture of distributed puncturing from the top/middle and/or weight-1 column reduction from the bottom may be used, as depicted in FIG. 19. A punctured bit (e.g., as indicated by 1904) may result from the weight-1 column reduction from the bottom. One or more bits (e.g., as indicated by 1901, 1902, 1903) may be punctured from the distributed puncturing scheme.

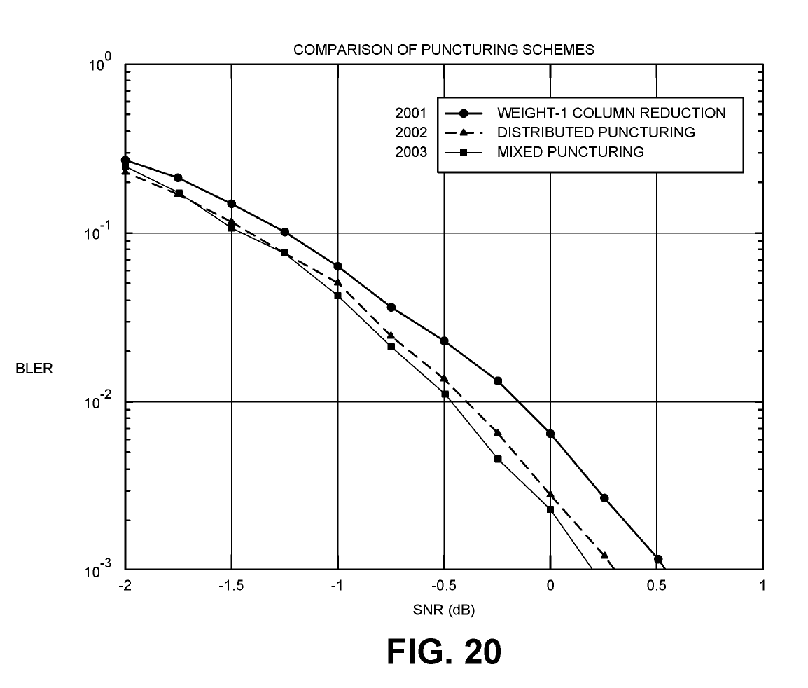

FIG. 20 is an example of a BLER performance comparison between a mixed puncturing scheme, a distribution puncturing scheme, and a weight-1 column reduction scheme. In an example, K=59 bits, N=256 bits, and 72 bits may be punctured from the 256 coded bits. QPSK modulations and AWGN channel may be used. FIG. 20 shows example results, wherein the mixed puncturing scheme outperforms a weight-1 column reduction scheme and a distribution puncturing scheme.

Polar encoding and decoding sub-systems may be used. A polar coding communication system may be an adaptive system.

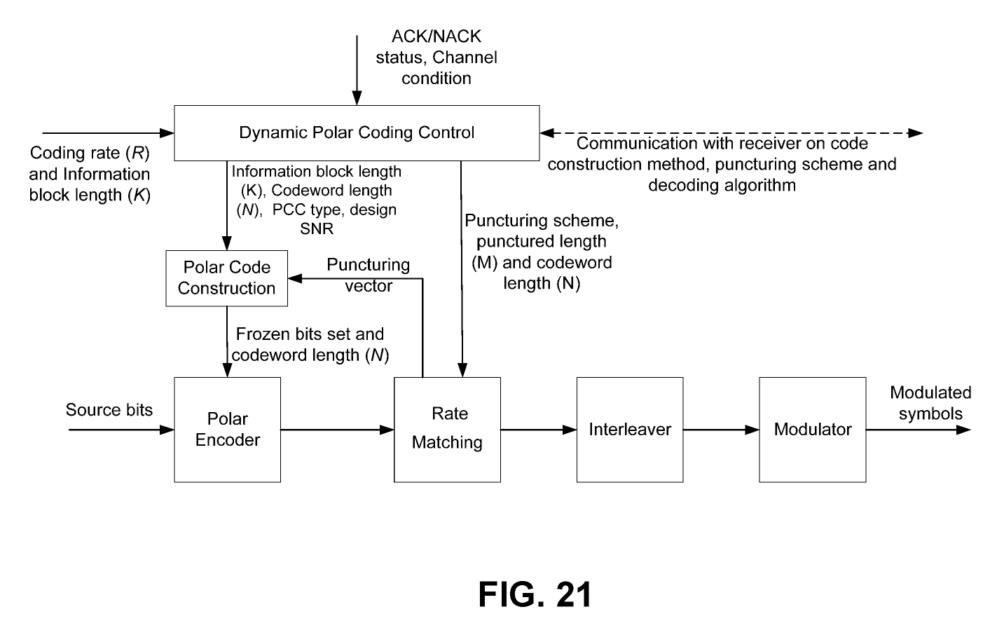

FIG. 21 is an example of an adaptive polar encoding sub-system. For example, a polar coding communication system may include an encoding sub-system, as shown in FIG. 21.

A polar coding controller (e.g., a dynamic polar coding controller, such as illustrated in FIG. 21) may perform one or more functionalities. A polar coding controller may calculate a codeword length N and/or the number of punctured bits M (e.g., punctured length M), for example, from information block length K and coding rate R. The value of N may be set as the smallest power of 2 larger than

$$\frac{K}{R}$$

and/or the value of M may be set to

$$N - \frac{K}{R} .$$

The value that N and M are set to may be passed to a polar code construction and/or a rate matching.

A polar coding controller may determine the type (e.g., construction type) of polar codes to be used. Polar code types (e.g., construction types) may include one or more of the following, in any combination. Bhattacharyya bounds, Monte-Carlo estimation, full transition probability matrices estimation, Gaussian approximation, SNR-independent construction, and/or PC polar code construction. Different codes may have different implementation complexity and/or different performance, for example, under one or more channel conditions. A decision about which polar codes type(s) (e.g., construction type) to use may depend on data QoS, channel condition, decoding error statistics, and/or capabilities of devices (e.g., transmitter and receiver). A polar coding controller may determine a design SNR to use. For example, a polar coding controller may determine a design SNR to use for a given type (e.g., construction type) of polar code. A decision on which polar code(s) to use may be passed to a polar code construction.

A polar coding controller may determine the type of puncturing scheme to be used. Puncturing schemes may include one or more of the following, in any combination. Quasi-uniform puncturing, weight-1 column reduction puncturing, and/or hybrid or mixture of quasi-uniform puncturing and weight-1 column reduction puncturing. A polar coding controller may send the information of a selected puncturing scheme, the punctured length, and/or the codeword length to a rate matching, as provided herein.

A polar coding controller may monitor channel conditions and/or ACK/NACK status. A polar coding controller may determine whether to update polar codes. For example, the polar coding controller may determine whether to update polar codes based on the monitored information.

A polar coding controller may control communications with a receiver. Communications may include one or more of the following, in any combination. Initial communication with a receiver on the type (e.g., construction type) of polar codes and associated design SNR, type(s) of puncturing schemes, codeword length, the number of punctured bits, decoding algorithms, etc. A polar coding controller may communicate with a receiver for an agreement. For example, a polar coding controller may communicate with a receiver for an agreement when the polar coding controller determines to update polar codes. A polar coding controller may update a polar code construction and/or rate matching. For example, a polar coding controller may update a polar code construction and/or rate matching when the polar coding controller receives a request for a polar code update from a receiver.

Polar code construction may provide the rank of bit channels. The rank of bit channels may be used to determine a set of frozen bits. Calculation of bit channel rank may be based on the type (e.g., construction type) of polar codes, puncturing vector, number of punctured bits, and/or codeword lengths.

A polar code construction may be generated. For example, a polar code construction may be generated for each request the polar coding controller receives a request for a polar code update from a receiver. Generation may include one or more of inputs of information block length, codeword length, code type, design SNR, punctured length, and/or puncturing vector.

A polar code may be pre-generated and/or stored. A pre-generated polar code may be based on different values of information block length, codeword length, code type, design SNR, punctured length, and/or puncturing vector. For a (e.g., each) new set of input parameters, the polar code construction block may select a polar code from a stored polar code. Post-processing may be applied on the selected polar code. For example, a selected polar code may be designed for a codeword length N₁. A polar code (e.g., a required polar code) may be for codeword length N₂, which may be less than N₁. A pruning from N₁ to N₂ may be applied. For example, a pruning from N₁ to N₂ may be applied by removing indices (e.g., all indices) with values between N₁ and N₂ in the bit channel rank.

As illustrated in FIG. 21, a polar encoder may encode source bits based on a polar code. A polar encoder may implement the function of G_{N}=B_{N}F^{⊗n}. B_{N} may be a bit-reversal permutation matrix, (.)^{⊗n} may denote the n-th Kronecker power and

$$F = [ \begin{matrix}1 & 0 \\ 1 & 1\end{matrix} ] .$$

A polar encoder may generate the vector u_{N}. For example, a polar encoder may generate the vector u_{N} by moving source bits to the non-frozen set and/or applying matrix multiplication operations of u_{N}·G_{N}. An N-bit output may be passed to rate matching.

Rate matching may compute the puncturing vector. For example, rate matching may compute the puncturing vector based on the puncturing scheme, punctured length, and/or codeword length input from the polar coding controller (e.g., the dynamic polar coding control). The calculated puncturing vector may be sent to the Polar Code Construction. The Rate Matching may execute the puncturing operations on the N input bits to N−M bits, e.g., based on the puncturing vector.

Interleaving may be performed. For example, an Interleaver may interleave N−M bits and/or pass the result to the Modulator. An Interleaver may provide better performance with polar codes.

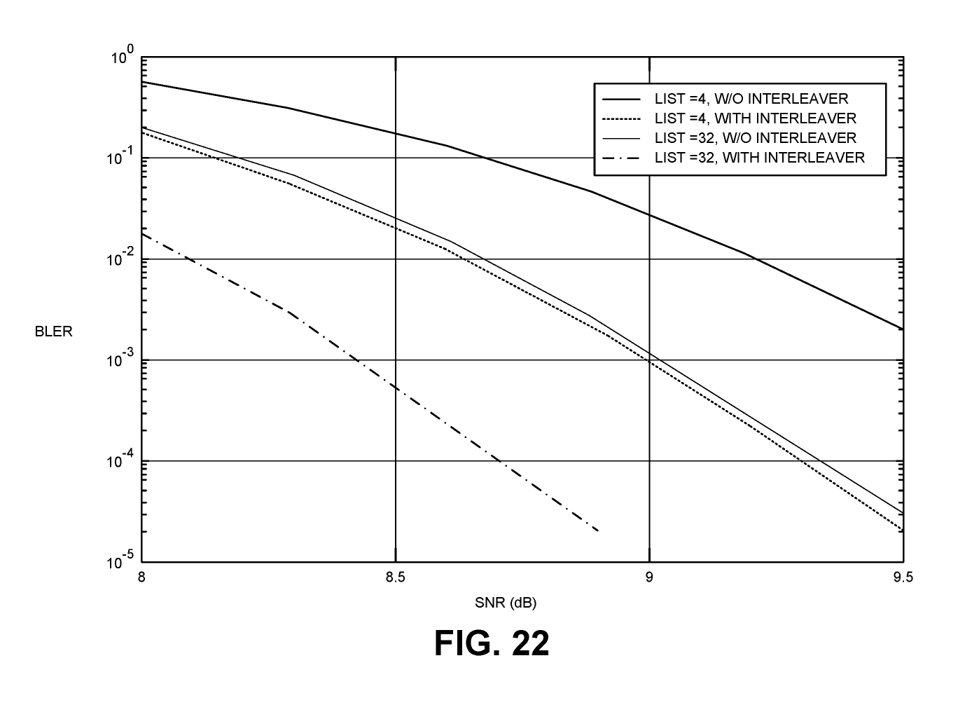

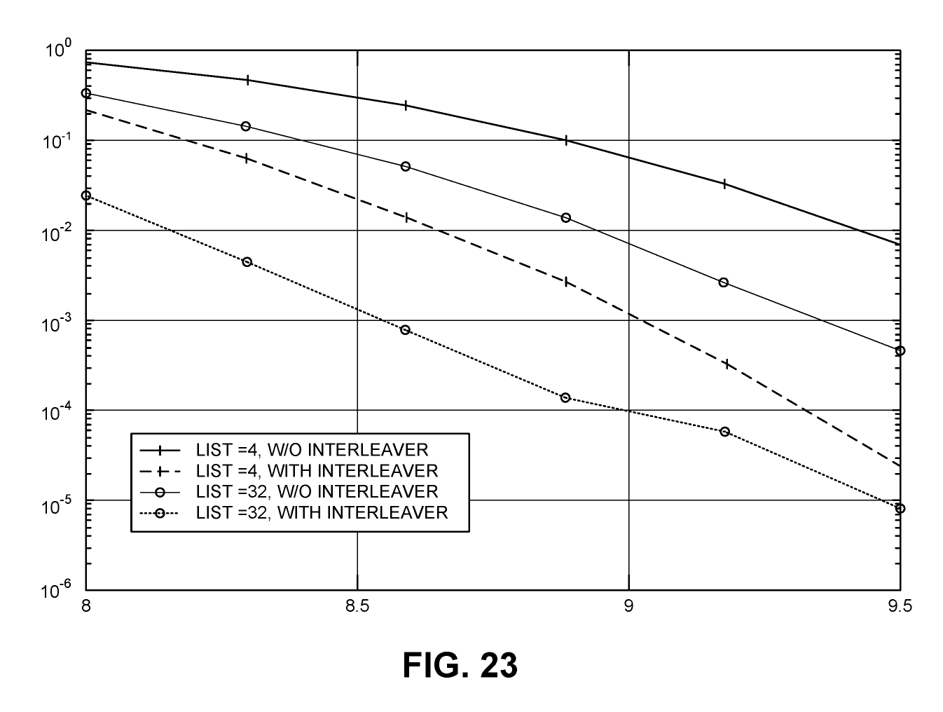

An Interleaver (e.g., a random interleaver) may be applied for polar codes. An example performance with a random interleaver is shown in FIG. 22 and FIG. 23.

FIG. 22 is an example of a BLER performance comparison with a polar code of Bhattacharyya bounds. FIG. 22 shows example results of BLER performance with and without a random interleaver. An example configuration may include N=4096, M=28, K=1356, 64-QAM modulation, an AWGN channel, a polar code based on Bhattacharyya bounds with design SNR being 0 dB, application of a weight-1 column reduction puncturing scheme, and/or application of a CRC-Aided SCL decoding with list sizes of 4 and 32. The example shown in FIG. 22 indicates that the BLER performance may increase about 0.6 dB at 1% or 0.1% target BLER level, e.g., when applying a random interleaver block.

FIG. 23 is an example of BLER performance comparison with a polar code of Gaussian approximation. FIG. 23 shows example results of BLER performance with and without a random interleaver. The polar code may be based on Gaussian approximation with design SNR being −3.3 dB. One or more settings for the example shown in FIG. 22 may be maintained for the example shown in FIG. 23. The example shown in FIG. 23 may indicate that BLER performance increases about 0.8 dB at 1% or 0.1% target BLER level, e.g., when applying the random interleaver block.

In examples, a (sub-block) interleaver used for turbo codes in LTE systems may be applied for polar codes.

In an example, x₀, x₁, . . . , X_{N-M-1} may be the outputs of rate matching and/or the inputs to the interleaver. C^{PC} may be an integer smaller than N−M. C^{PC} may be a power of 2. The selection of C^{PC} may depend on the resource blocks to be assigned to data or on a modulation order. R^{PC} may be the smallest integer larger than

$$\frac{N - M}{{C}^{PC}} .$$

D may be given by Eq. 1:

D=C^{PC}·R^{PC}−(N−M) Eq. 1

Operations may be performed on sub-blocks or on an entire block with N-M output bits of the rate matching. A modulator may apply modulation mappers on input bits.

An operation may be performed according to Eq. 2:

$$Set {y}_{i} = \{ \begin{matrix}- 1 , & 0 \leq i \leq D - 1 \\ {x}_{i - D + 1} & i \geq D - 1\end{matrix} \qquad Eq . 2$$

Dummy bits (e.g., valued −1) may be inserted at one or more locations(s). For example, dummy bits may be inserted at the beginning of a code-block, at the end of the code-block, in between code-blocks, etc. Dummy bits may be inserted at one or more locations(s) when the location(s) are agreed on by transmitter and receiver.

A y sequence may be filled into a matrix according to Eq. 3:

$$[ \begin{matrix}{y}_{0} & {y}_{1} & … & {y}_{C}^{PC} - 1 \\ {y}_{C}^{PC} & {y}_{C}^{PC} + 1 & … & {y}_{2 C}^{PC} - 1 \\ … & … & & … \\ {y}_{C}^{PC} * ( {R}^{PC} - 1 ) & … & … & {y}_{C}^{PC} * {R}^{PC} - 1\end{matrix} ] \qquad Eq . 3$$

A permutation (e.g., a bit reversal permutation) may be performed on columns in the matrix.

Interleaver outputs may be a bit sequence. For example, interleaver outputs may be the bit sequence read out (e.g., column by column) from the inter-column permutated matrix. Interleaver outputs v₀, v₁, . . . , v_{R}_{^{PC}}_{.C}_{^{PC}} may be given by vᵢ=y_{π(i)}, for example, based on Eq. 4:

$$π ( i ) = ( P ⌊ \frac{i}{{R}^{PC}} ⌋ + {C}^{PC} \cdot ( i mod {R}^{PC} ) ) mod ( {R}^{PC} \cdot {C}^{PC} ) \qquad Eq . 4$$

where P may correspond to the bit reversal permutation. Dummy bits (e.g., with values −1) may be skipped at the output of the interleaver.

An offset may be applied to the index while reading the bits.

The QPP interleaver used for turbo codes (e.g., turbo codes in LTE systems) may be applied for polar codes.

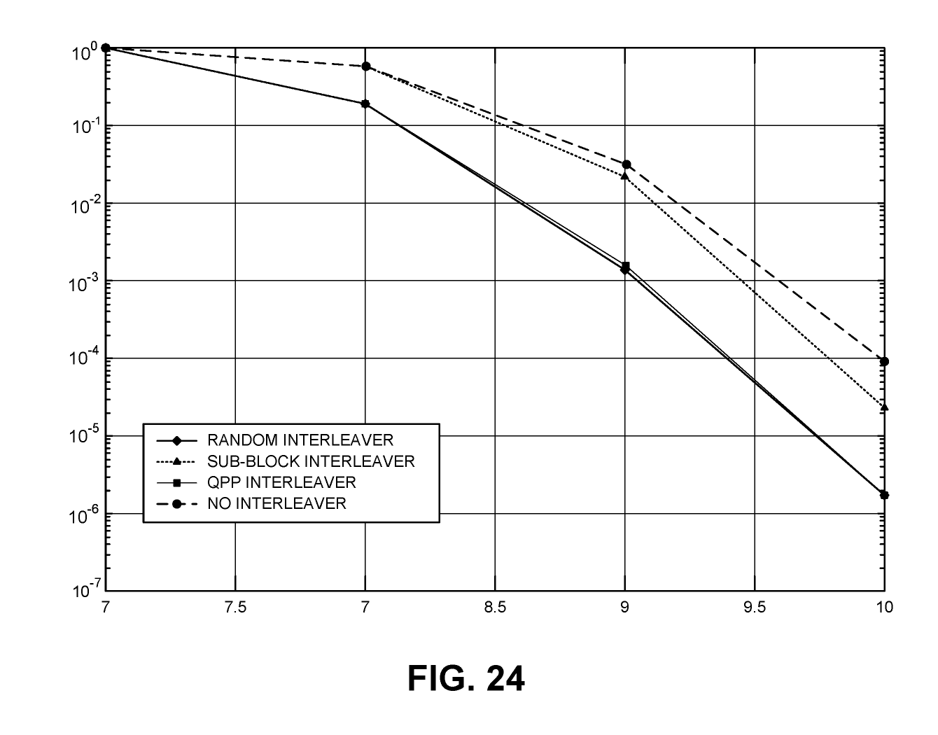

FIG. 24 is an example of BLER performance comparison with a polar code of Bhattacharyya bounds for different interleavers for 64QAM modulation. Results of BLER performance are shown with a random interleaver, an LTE sub-block interleaver, an LTE QPP interleaver, and without an interleaver. An example configuration may include N=4096, M=28, K=1356, 64-QAM modulation, an AWGN channel, a polar code based on Bhattacharyya bounds with design SNR being 0 dB, application of a weight-1 column reduction puncturing scheme and application of a CRC-Aided SCL decoding with the list size of 4. A QPP interleaver may have a similar performance as a random interleaver. A QPP interleaver and a random interleaver may outperform sub-block interleaver and no interleaver.

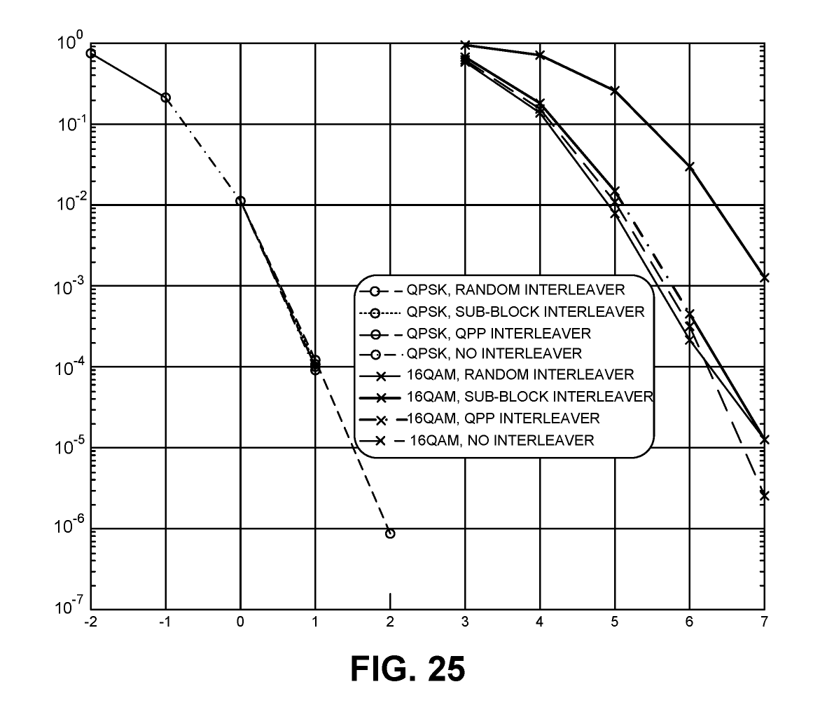

FIG. 25 is an example of BLER performance comparison with a polar code of Bhattacharyya bounds for different interleavers for QPSK and 16QAM modulations. Results of BLER performance are shown with QPSK and a random interleaver, QPSK and an LTE sub-block interleaver, QPSK and an LTE QPP interleaver, QPSK without an interleaver, 16QAM and a random interleaver, 16QAM and an LTE sub-block interleaver, 16QAM and an LTE QPP interleaver, and 16QAM without an interleaver. An example configuration may include N=512, M=3, K=170, QPSK or 16-QAM modulation, an AWGN channel, a polar code based on Bhattacharyya bounds with design SNR being 0 dB, application of a weight-1 column reduction puncturing scheme, and/or application of a CRC-Aided SCL decoding with the list size of 4. The schemes (e.g., all the schemes) may have similar performance for QPSK modulation. For 16QAM modulation, the random interleaver, QPP interleaver, and/or no interleaver may have similar performance, which may outperform a sub-block interleaver.

Determination of the interleaving schemes for polar codes may depend on the modulation order. An interleaver may be used for high order modulation. An interleaver may not be used for low order modulation. For example, for 64 QAM modulation, a QPP interleaver may be applied to achieve good performance and/or may keep the implementation simple. For QPSK modulation and/or 16QAM modulation, an interleaver may not be applied. For example, an interleaver may not be applied to save computation complexity.

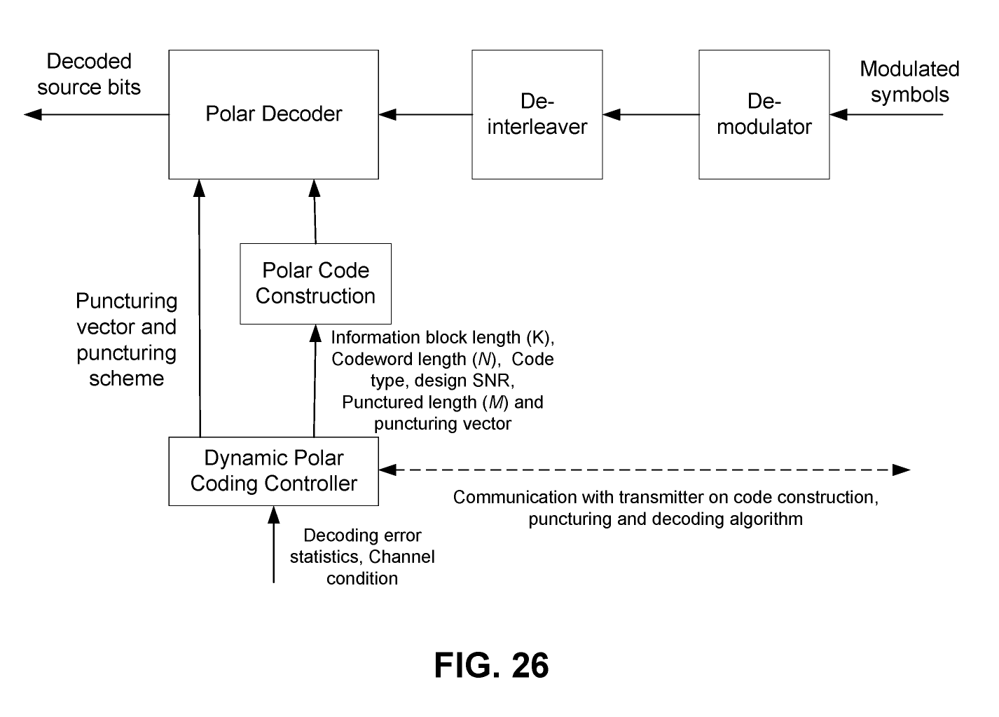

FIG. 26 is an example of an adaptive polar decoding sub-system.

A de-modulator may calculate the Log-Likelihood (LL) or Log-Likelihood Ratio (LLR). For example, a de-modulator may calculate the Log-Likelihood (LL) or Log-Likelihood Ratio (LLR) for a bit from received symbols.

A de-Interleaver may apply the reverse operation of the Interleaver.

A polar coding controller may be a dynamic polar coding controller. For example, a polar coding controller may be the example Dynamic Polar Coding Controller shown on FIG. 26. A polar coding controller may collect information (e.g., may collect information from the transmitter). For example, a polar coding controller may collect information about codeword length N, the number of punctured bits M, the type (e.g., construction type) of polar codes, the design SNR, and/or the puncturing scheme to be used. The values of N, M, and/or the type (e.g., construction type) of polar code information may be passed to polar code construction. Puncturing scheme information may be passed to the polar decoder.

A polar coding controller may generate the puncturing vector. The polar coding controller may generate the puncturing vector based on the type of puncturing schemes and/or the number of punctured bits M. The puncturing vector may be passed to polar code construction and/or the polar decoder.

A polar coding controller may monitor decoding error statistics and/or channel conditions. The polar coding controller may determine whether to update the polar codes. For example, the polar coding controller may determine whether to update the polar codes based on monitored information.

A polar coding controller may control communication with a transmitter. The communication may include one or more of the following, in any combination. Initial communication with the transmitter on the type (e.g., construction type) of polar codes, the type of puncturing schemes, the codeword length and the number of punctured bits, decoding algorithms, etc. A polar coding controller may communicate with the transmitter (e.g., may communicate with the transmitter for an agreement). For example, a polar coding controller may communicate with the transmitter when the polar coding controller updates polar codes. A polar coding controller may update polar code construction and/or the polar decoder. For example, a polar coding controller may update polar code construction and/or the polar decoder when the polar coding controller receives a request to update polar codes (e.g., from a transmitter).

Polar code construction may provide the rank of bit channels. The rank of bit channels may be used to determine (e.g., may subsequently be used to determine) the set of frozen bits. Calculation of bit channel rank may be based on the type of the polar codes, the puncturing vector, the number of the punctured bits, and/or codeword lengths.

The polar decoder may apply one or more of the following polar decoding schemes, in any combination. Successful Cancellation decoding, Successive Cancellation List (SCL) decoding, and/or CRC-Aided SCL decoding. A message (e.g., an LLR and/or LL) from the De-Interleaver may (e.g., only) contain data for un-punctured bits. The un-punctured bits may include positions provided by a puncturing vector passed by the polar coding controller (e.g., the dynamic polar coding controller). The polar decoder may set the corresponding LLR as 0 or infinite. For example, the polar decoder may set the corresponding LLR as 0 or infinite for the punctured bits, for example, depending on the puncturing scheme used. A corresponding LLR may be set to 0. For example, for QUP, a corresponding LLR may be set to 0. A corresponding LLR may be set to infinite. For example, for weight-1 column reduction puncturing, a corresponding LLR may be set to infinite. The LLR and/or LL may be used by a polar decoding algorithm.

Adaptive polar codes may be implemented for a MIMO system. Different layers (e.g., in a MIMO system) may experience different channel conditions. Different channel SNR and/or CQI may be reported for different layers. Different design SNR may be selected for different layers. Multiple polar encoders may be used for multiple codewords (CW) in a MIMO system. A design SNR for multiple polar encoders may be determined for a MIMO system. For example, depending on a rank condition, layer mapper, and/or CQI reporting, a design SNR for multiple polar encoders may be determined for a MIMO system. A CW may be mapped to one or more spatial layers. Mapping a CW to one or more spatial layers may result in a different design SNR for polar encoders.

A design SNR may be selected in one or more of the following ways, such as one or more (e.g., a combination or hybrid) of the following. (i) A different design SNR may be used for a polar encoder per spatial layer. For example, a different design SNR may be used for a polar encoder per spatial layer when per-layer CQI may be reported; (ii) A design SNR (e.g., the same design SNR) may be used for a polar coding system for different spatial layers belonging to the same CW. For example, the same design SNR may be used for a polar coding system for different spatial layers belonging to the same CW when per-layer CQI is not be available. Averaged SNR or CQI over two or more layers may be reported (e.g., CQI per CW reported); (iii) Design SNR may be determined. For example, design SNR may be determined based on Eigen values of MIMO channels; and/or (iv) Different design SNRs may be determined for different layers. For example, different design SNRs may be determined for different layers based on an RI and/or Pre-coding Matrix Indicator (PMI) matrix.

Systems, methods, and instrumentalities have been disclosed for polar code adaptation. Polar codes may be adapted (e.g., may be adapted for performance) by adapting, modifying, and/or changing a polar code construction parameter. For example, a polar code construction parameter may be adapted, modified, and/or changed based on monitored information. The monitored information may include a communication channel condition, a decoding error statistic, and/or a communication device capability. Polar code adaptation may comprise selecting one or more of the following, in any combination. A different design SNR, a different type (e.g., construction type) of polar code, a different puncturing scheme, a different codeword length, and/or a different number of punctured bits. For example, a channel SNR-based adaptive Polar coding system may achieve better performance by adapting to different channel conditions. Individual, or combined (e.g., hybrid) puncturing schemes (e.g., mixing a quasi-uniform scheme and a weight-1 column reduction scheme), may be adapted, modified and/or changed. Polar encoding and decoding subsystems may provide adaptations, including for MIMO systems.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. A WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) for polar coding, comprising:
a processor configured to:
identify a coding rate and an information block length;
determine a codeword length based on the coding rate and the information block length;
identify a channel condition;
determine a design signal to noise ratio (SNR) based on a polar code construction type, wherein the polar code construction type is based on the channel condition;
determine a polar code based on the information block length, the codeword length, the polar code construction type, and the design SNR; and
encode source bits based on the polar code.

2. The WTRU of claim 1, wherein the processor is configured to:
determine a punctured length based on the coding rate and the information block length;
determine a puncturing scheme based on the channel condition, the information block length, the coding rate, the punctured length, and a polar decoding algorithm;
determine a puncturing vector based on the puncturing scheme, the punctured length, and the codeword length; and
determine the polar code further based on the punctured length and the puncturing vector.

3. The WTRU of claim 2, wherein the processor is configured to:
determine a rank of bit channels based on any of: the polar code construction type, the puncturing vector, the punctured length, or the codeword length; and
determine frozen bits based on the rank of bit channels.

4. The WTRU of claim 2, wherein the determined punctured length is the codeword length minus the information block length divided by the coding rate.

5. The WTRU of claim 2, wherein the processor is configured to send any of: the polar code construction type, the design SNR, the polar decoding algorithm, or the puncturing scheme to a receiver.

6. The WTRU of claim 2, wherein the processor is configured to interleave a number of interleaver bits, wherein the number of interleaver bits is equal to the codeword length minus the punctured length.

7. The WTRU of claim 6, wherein the processor is configured to interleave the number of interleaver bits based on a modulation order.

8. The WTRU of claim 1, wherein the processor is configured to:
identify decoding error statistics;
determine the polar code construction type based on the decoding error statistics; and
determine the design SNR based on the decoding error statistics.

9. The WTRU of claim 1, wherein the polar code construction type comprises any of: Bhattacharyya bounds, a Monte-Carlo estimation, a full transition probability matrices estimation, a Gaussian approximation, a signal to noise ratio (SNR)-independent construction, or a parity check (PC)-polar code construction.

10. The WTRU of claim 1, wherein the polar code construction type is further determined based on a capability of the WTRU.

11. The WTRU of claim 1, wherein the channel condition comprises a signal to noise ratio (SNR).

12. The WTRU of claim 1, wherein the determined codeword length is a smallest power of two larger than the information block length divided by the coding rate.

13. The WTRU of claim 1, wherein the processor is configured to receive the coding rate and an information block length from a MAC layer.

14. A method for polar coding, comprising:
identifying a coding rate and an information block length;
determining a codeword length based on the coding rate and the information block length;
identifying a channel condition;
determining a design signal to noise ratio (SNR) based on a polar code construction type, wherein the polar code construction type is based on the channel condition;
determining a polar code based on the information block length, the codeword length, the polar code construction type, and the design SNR; and
encoding source bits based on the polar code.

15. The method of claim 14, further comprising:
determining a punctured length based on the coding rate and the information block length;
determining a puncturing scheme based on the channel condition, the information block length, the coding rate, the punctured length, and a polar decoding algorithm;
determining a puncturing vector based on the puncturing scheme, the punctured length, and the codeword length; and
determining the polar code further based on the punctured length and the puncturing vector.

16. The method of claim 15, wherein the determined punctured length is the codeword length minus the information block length divided by the coding rate.

17. The method of claim 15, wherein encoding the source bits based on the polar code comprises:
determining a rank of bit channels based on any of: the polar code construction type, the puncturing vector, the punctured length, or the codeword length; and
determining frozen bits based on the rank of bit channels.

18. The method of claim 14, comprising:
identifying decoding error statistics;
determining the polar code construction type based on the decoding error statistics; and
determining the design SNR based on the decoding error statistics.

19. The method of claim 14, wherein the polar code construction type comprises any of: Bhattacharyya bounds, a Monte-Carlo estimation, a full transition probability matrices estimation, a Gaussian approximation, a signal to noise ratio (SNR)-independent construction, or a parity check (PC)-polar code construction.

20. The method of claim 14, wherein the determined codeword length is a smallest power of two larger than the information block length divided by the coding rate.
